(19) United States
(12) Patent Application Publication
(10) Pub. No.: US 2023/0061739 A1
(43) Pub. Date: Mar. 2, 2023

(54) CUSTOM BEVERAGE CREATION DEVICE, SYSTEM, AND METHOD

(71) Applicant: Be the Change Labs, Inc., New York, NY (US)

(72) Inventors: Lee von Kraus, Brooklyn, NY (US); Sunjay Guleria, New York, NY (US); Grant Kenji Larsen, Millbrook, NY (US); Marcel Ipince, Mamaroneck, NY (US); Cameron Hughes, New York, NY (US); Mohini Boparai Guleria, Amsterdam (NL)

(21) Appl. No.: 17/758,328

(22) PCT Filed: Dec. 30, 2020
(86) PCT No.: PCT/US2020/067403

§ 371 Date: Jul. 1, 2022

Related U.S. Application Data
(60) Provisional application No. 62/956,798, filed on Jan. 3, 2020.

(51) Int. Cl. B67D 1/00; A23L 2/54; A47J 31/40

(52) U.S. Cl. CPC B67D 1/0021; A23L 2/54; A47J 31/407; B67D 1/0051; B67D 1/0071; B67D 2001/0812

(57) ABSTRACT

A system for dispensing fluid is provided in which a first fluid cartridge and a second fluid cartridge each comprise a first spout at corresponding fluid outlets, and wherein a docking location is provided for docking each of the fluid cartridges such that the first spout is adjacent the second spout. The system may further comprise a drop sensor for detecting a number of drops dispensed from the fluid cartridges at a drop detection location. The docking location may define a specific orientation for any cartridge docked at the docking location, and the cartridges may be wedge shaped and may each taper towards their corresponding spouts. Also provided is a fluid cartridge comprising a cartridge housing, a fluid inlet, a fluid outlet above a fluid fill level, and a syphon for transporting fluid from inside the cartridge to the fluid outlet.

### FIELD OF THE INVENTION

This application claims the benefit of U.S. Provisional Pat. Application No. 62/956,798, filed Jan. 3, 2020, and the contents of which are incorporated by reference herein in their entirety.

### FIELD OF THE INVENTION

The invention relates to custom beverage creation devices, systems, and methods including such devices for flavoring, filtering, and carbonating beverages.

### BACKGROUND

Traditionally, people buy beverages from a local store, or more recently, via online delivery services. Such beverages can include flavored drinks, carbonated drinks, and even something as basic as filtered water. These drinks are sometimes purchased in large quantities of vessels. These vessels can be bottles, each of which may hold, for example, 1 liter of water, or larger containers. When the contents of one vessel have been consumed, another vessel is retrieved and opened for consumption. This process is quite convenient, requiring only occasional trips to the store (or online clicks in the instance of online-ordered beverages), and occasional disposal and replacement of empty vessels. While this method of beverage acquisition is simple, it generates a significant amount of waste (usually plastic waste, since vessels are usually made of plastic). As such, the development of an at-home beverage creation system holds promise for reducing waste.

In the development of an at-home beverage creation system, the convenience of beverage creation is ideally close to, or better than, the convenience of existing methods of beverage acquisition, which have been described above. In particular, to further reduce the effort involved in existing beverage acquisition methods, one could further eliminate at least some of the problems of 1) needing to go to the store to restock on beverage vessels, 2) needing to dispose of empty vessels, and needing to store crates of full vessels. These problems should be solved while also 3) avoiding the introduction of significant new inconveniences. Further, a beverage creation system may introduce new advantages, such as the consistent creation of custom beverages at lower cost than traditional beverage purchasing.

There is a need for beverage creation devices, systems, and methods that can repeatably flavor beverages and increase the absorption of CO2 in a liquid and/or allow the fluid to retain CO2 at a higher rate than existing devices.

### SUMMARY

Automated liquid dosing systems are described, in which dispensation of a specified number of liquid droplets (-0.05 ml per droplet) from a container of liquid (a “Pod” or “fluid cartridge”) is achieved by a closed loop system of actuators and sensors (the “Pod Dock”), with no physical contact between the Pod’s dispensed liquid and the Pod Dock. In preferred embodiments, the Pod Dock actuators and sensors are air pumps and capacitive sensors, respectively, and the Pods have an air inlet orifice and a liquid output orifice, and can be magnetically coupled to the Pod Dock. In this preferred embodiment, air is pumped from the Pod Dock into the Pod, thereby pressurizing the Pod, and forcing liquid out of the Pod’s output orifice in the form of droplets that can be counted by the Pod Dock’s capacitive sensor in real time as they are dispensed.

In some embodiments, a system is provided for dispensing fluid, the system comprising a first fluid cartridge comprising a first fluid outlet for dispensing fluid and a second fluid cartridge comprising a second fluid outlet for dispensing fluid. The system may further comprise a first docking location for docking the first fluid cartridge and a second docking location for docking the second fluid cartridge. Each docking location has a magnetic fixation location for mating with a ferromagnetic material on the corresponding fluid cartridge.

In some embodiments, the first and second docking locations require that the corresponding fluid cartridge be docked in a specific orientation. In some such embodiments, the docking locations may be located within a docking housing, and the docking housing may have a top surface, a plurality of side surfaces, and at least one back surface, and a front of the docking housing may then be open. The magnetic fixation location for each docking location may then be at least partially located at the top surface adjacent the front of the docking housing.

In some such embodiments, each docking location is adjacent a side surface of the docking housing, and the magnetic fixation location for each docking location may then comprise a first magnetic element at the top surface adjacent the front of the docking housing and a second magnetic element adjacent the side surface adjacent the corresponding docking location. In some such embodiments, the first magnetic element of the magnetic fixation location for the first docking location and that for the second docking element are segments of the same magnetic element.

In some embodiments, the ferromagnetic material for each fluid cartridge comprises an L shaped segment at or near a top surface of the cartridge adjacent two side surfaces of the corresponding fluid cartridge. In some such embodiments, the first fluid outlet of the first fluid cartridge is adjacent a corner of the cartridge opposite the ferromagnetic material of the first fluid cartridge.

In some embodiments, the first fluid cartridge further comprises an inlet orifice for applying pressure to an interior of the first fluid cartridge, the inlet orifice being adjacent the corner of the L shaped segment of ferromagnetic material of the first fluid cartridge.

In some such embodiments, the docking location further comprises a pump outlet located adjacent a corner of the magnetic fixation location where the first magnetic element and the second magnet element meet for each docking location, such that when the first fluid cartridge is located at the first docking location and the magnetic fixation location is fixed to the ferromagnetic material, the pump outlet is coupled to the inlet orifice of the first fluid cartridge, and wherein when pressure is applied to the first fluid cartridge at the inlet orifice, fluid from the cartridge is dispensed from the fluid outlet.

In some embodiments, the first fluid cartridge comprises a rectangular upper segment and a non-rectangular lower segment, such that at least a first portion of the upper segment is not above the lower segment when vertically oriented.

In some such embodiments, the first fluid outlet may be located at the first portion of the upper segment. In some such embodiments, the first fluid outlet may be adjacent the at least one back surface when the first fluid cartridge is in the specific orientation. In some such embodiments, at least two sidewalls of the lower segment are coextensive with at least two sidewalls of the upper segment of the first fluid cartridge, and the at least one back surface comprises a bracing element for contacting a sidewall of the lower segment that is not coextensive with a corresponding sidewall of the upper segment.

In some such embodiments, the bracing element comprises a vertical wall angled relative to the at least one back surface of the docking location, and the lower segment of the first fluid cartridge is opposite the bracing element from the first spout.

The bracing element may comprise two vertical walls forming a triangle with the at least one back surface at a center of the back surface, such that a first of the two vertical walls contacts the sidewall of the lower segment of the first fluid cartridge and wherein a second of the two vertical walls contacts an equivalent sidewall of the second fluid cartridge, thereby orienting both the first fluid cartridge and the second fluid cartridge in their respective specific orientations.

In some embodiments, the first magnetic element forms a magnetic hinge with the ferromagnetic material of the cartridge, such that when a lower end of the first fluid cartridge is pulled away from the at least one back surface of the docking housing, the first fluid cartridge rotates about the first magnetic element.

In some embodiments, the ferromagnetic material is metal. In some embodiments, the ferromagnetic material is a magnet.

### BRIEF DESCRIPTION OF THE DRAWINGS

FIG. 1 is a block diagram of a custom beverage creation device.

FIG. 2 is a perspective view of a custom beverage creation device implementing the features of FIG. 1.

FIG. 3 is a perspective view of the device of FIG. 2 with a cover removed.

FIGS. 4A-C are perspective views of three embodiments of a custom beverage creation device.

FIG. 5 is a close up view of additive cartridges incorporated into the custom beverage creation device of FIG. 4A.

FIG. 6 is a schematic diagram of a pump implementation for dispensing additives from additive cartridges into beverages created by the custom beverage creation device of FIG. 1.

FIG. 7 shows a perspective view of the additive cartridges dispensing additives in the context of the device of FIG. 1.

FIGS. 8A-C show alternative implementations of additive cartridges for use with the device of FIG. 1.

FIG. 9 shows a schematic diagram of an output tube for use in the context of the additive cartridges shown in FIGS. 8A-C

FIGS. 10A, B, and C show views of an embodiment of an additive cartridge according to this disclosure.

FIGS. 11A and B show views of an embodiment of an additive cartridge according to this disclosure.

FIG. 12 shows components of a deconstructed syphon tube for use in cartridges for use with the device of FIG. 1.

FIGS. 13A-B should the incorporation of the deconstructed syphon tube of FIG. 12 in additive cartridges.

FIG. 14 shows a magnetic seal for use with a cartridge.

FIGS. 15A-B show an assembly for counting drops dispensed from a cartridge.

FIG. 15C shows a bleed valve for use in the assembly of FIGS. 15A-B.

FIGS. 16A-D show a cartridge for use in the assembly of FIGS. 15A-B.

FIG. 17 shows an overhead view of multiple cartridges in the assembly of FIGS. 15A-B.

FIG. 18 shows the use of a drop sensor in the view of FIG. 17.

FIGS. 19-20 show multiple cartridges in a docking location for use in the device of FIG. 1.

FIGS. 21A-C show an embodiment of a fluid cartridge for use in the device of FIG. 1.

FIG. 22 shows a docking housing for housing docking locations for mating with the fluid cartridge of FIGS. 21A-C.

FIG. 23 shows a schematic diagram of an embodiment of docking locations in the docking housing of FIG. 22.

FIG. 24 shows a schematic diagram of a second embodiment of docking locations in the docking housing of FIG. 22.

FIG. 25 shows a schematic diagram of a top face of the fluid cartridge of FIGS. 21A-C.

FIG. 26 shows a top view of the docking housing of FIG. 22.

FIGS. 27A-B show bottom views of the docking housing of FIG. 22.

FIGS. 28A-B show front views of the docking housing of FIG. 22.

FIG. 29 shows a user removing a fluid cartridge of FIGS. 21A-C from the docking housing of FIG. 22.

FIGS. 30-31 show alternative embodiments of drop sensors for use in the device of FIG. 1.

FIGS. 32A-B show a capacitive drop sensor for use in the device of FIG. 1.

FIG. 32C shows an example of data collected from the capacitive drop sensor shown in FIGS. 32A-B.

FIGS. 33A-B show two implementations of the capacitive drop sensor of FIGS. 32A-B into the device of FIG. 1.

FIG. 34 shows electrodes for use in the capacitive drop sensor of FIGS. 32A-B and 33A.

FIG. 35 shows the electrodes of FIG. 34 in use and compares them to the data of FIG. 32C.

FIG. 36 shows a fluid cartridge assembly, including a crimp and tube system, for use in the device of FIG. 1.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” ”vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

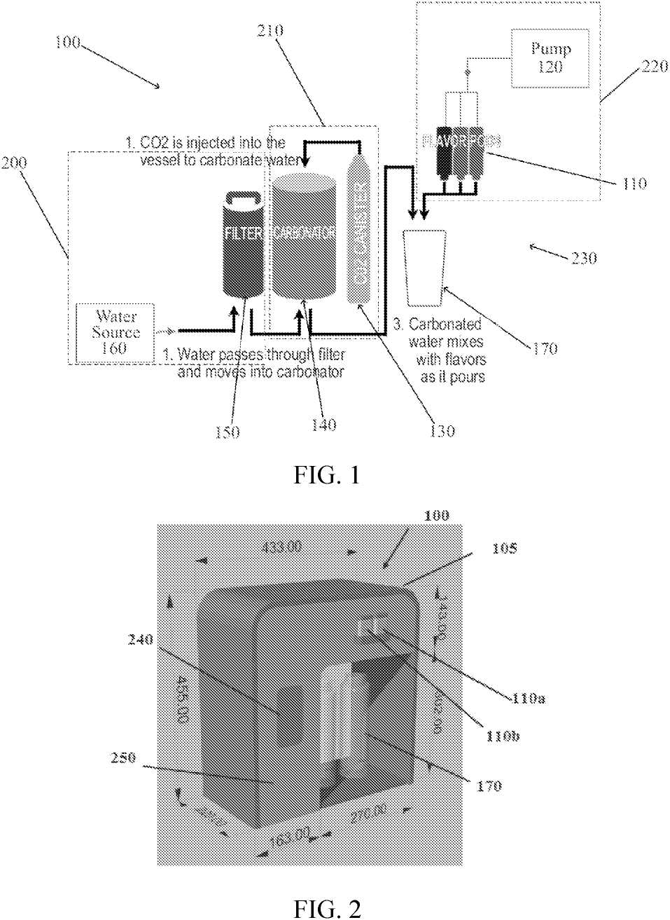

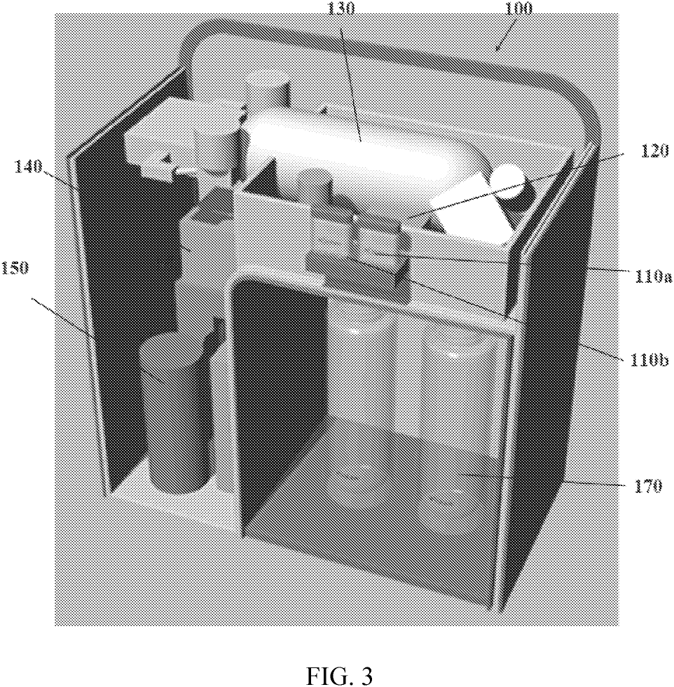

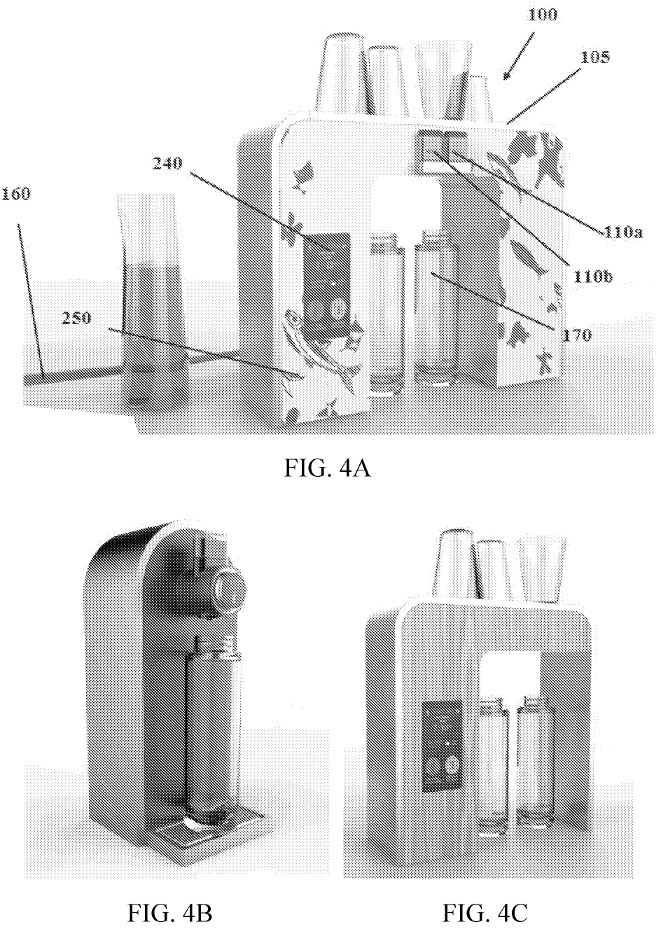

FIG. 1 is a block diagram of a custom beverage creation device 100, FIG. 2 is a perspective view of the device with a housing 105 in place, and FIG. 3 shows the device with the housing removed. FIGS. 4A-C are perspective views of three embodiments of the custom beverage creation device 100, shown with covers in place. As shown, the custom beverage creation device typically includes a filtration module, 200, a carbonation module 210, a flavor addition module 220, and an automated refill module 230.

The entirety of the device may be controlled by appropriate circuitry, including a microcontroller to control sequence and coordination of events in the operation of the device 100. Such circuitry may include memory for retaining programs for operating the device 100 and recipes for forming drinks as discussed below.

The flavor addition module 220 comprises additive cartridges 110, occasionally referred to herein as “syrup pods,” and a pump 120 or pumping system for pumping an additive out of the additive cartridges 110. The carbonation module 210 comprises a carbonation gas tank 130 and a carbonation vessel 140, and the filtration module 200 comprises a water filter 150, and a water source 160. The device shown creates custom beverages and then deposits the beverage into an exterior beverage vessel 170, such as a cup or a bottle, which beverage may be selected by a user, and which refill may be initiated by the automated refill module 230.

It will be understood that while a full featured embodiment is shown and described, beverage creation devices 100 in accordance with this disclosure may be provided with only one or several of the modules shown and described. Accordingly, while the description that follows is in the context of a device 100 having the various modules described, a standalone additive dispensing system may be provided to allow a user to add customized amounts of various additives, typically in the form of syrups, to a solution to create a custom beverage.

This system would typically comprise, for example, only the flavor addition module 220, thereby including an air pump 120, which pumps air into one or more cartridges 110. Air pumped into the cartridges 110 pushes the additive out of the cartridge and into a user’s beverage.

Such a system may be mounted on a stand or attached to a ferromagnetic surface, such as a refrigerator door, by magnets, and could be powered from a wall outlet or by battery power.

The dispensation of additive from each cartridge 110 may be carefully monitored using any of the methods described in more detail below, thereby allowing a user to have a high level of control over the exact amount of additive dispensed, and also high resolution control over the mixture ratios between the additives drawn from multiple cartridges 110. In this way, the standalone device bay may allow for use of specific user specified or software based recipes to replicate known beverages or user-designed recipes.

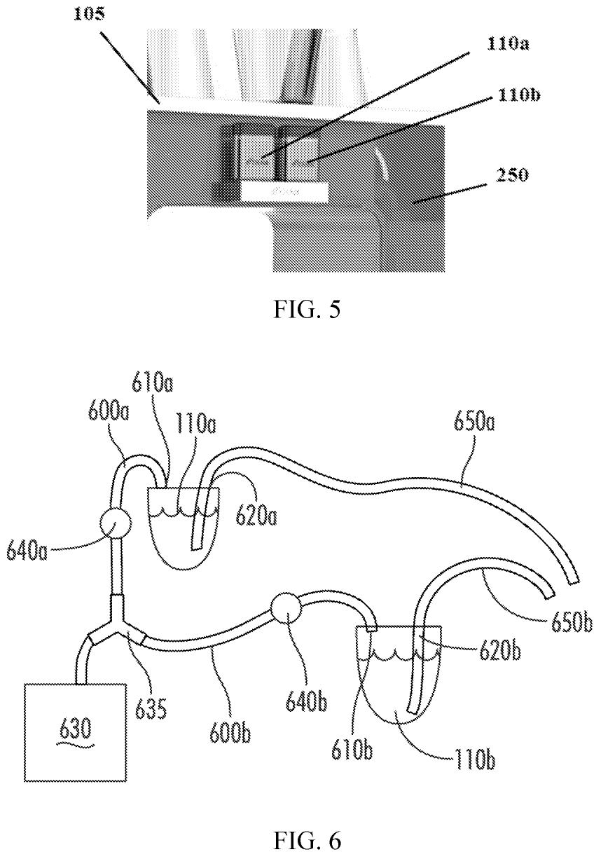

As shown in FIGS. 2 and 5, among others the additive cartridges 110 may be mounted in a docking location on a front surface of the housing 105, and a display 240 may be included with the housing. The display may be, for example, a touch screen for implementing control of the device 100. As shown in FIG. 3, the housing 105 may include a front faceplate 250 showing an aesthetic design. Such a faceplate 250 may be removable and exchangeable with different designs. A wide variety of docking locations may be implemented, several of which are shown and described below.

FIG. 5 is a close up view of multiple additive cartridges 110a, b incorporated into the custom beverage creation device 100 of the embodiment shown in FIG. 4A. During use, the pumping system 120 extracts additives, typically in syrup form, from the additive cartridges 110 and deposits them into the exterior beverage vessel 170 as part of a custom beverage created by the device 100.

FIG. 6 is a schematic diagram of the flavor addition module 220 of FIG. 1. As shown, the module comprises a pump 630 for dispensing additives from additive cartridges 110a, b into beverages as part of a fluid delivery system of the custom beverage creation device 100 of FIG. 1.

Typically, the machine 100 will be able to deliver a concentrated additive solution from an additive cartridge 110, occasionally referred to herein as a “pod,” into water to create custom beverages. It will be further understood that in some places, the additive is referred to as a “syrup,” and that while the additive is a syrup in a typical embodiment, it may be any additive, including a powder or liquid with appropriate modifications to the mechanisms described. For example, in some embodiments, the additive may be provided as a powder and water may be added to the cartridge prior to first use to form a syrup.

Accordingly, it would be possible for the cartridges 110 to also dispense powder-based additives (in addition to aqueous additives). This could be achieved by having either the machine or the consumer add water to the cartridge 110, thereby dissolving it and transforming it to an aqueous form, which could then be dispensed via the previous method described. For the device 100 to accomplish this would simply require the addition of a water-input line to the cartridge itself, which could be achieved in the same way as the air input line, either through a dedicated port, or through the same port as used by the air.

The pumping of the syrup from the additive cartridge 110 may be achieved by use of a pump 630, typically an air pump, such as a diaphragm or peristaltic pump, to pump the syrup from the cartridge into a vessel. This may be by pressurizing the air inside of the cartridge, thereby displacing the additive solution out of the pod and into a user’s vessel. To allow one pump to control the flow of syrup from several different additive cartridges 110a, b, the pump may be connected to the additive cartridges via a pressurized conduit, such as tubing, split into separate pressurized conduits, such as tubes 600a, b for each additive cartridge by a Y connector 635. Between the pump 630 and each cartridge 110a, b is a controllable valve 640a, b, which could be a solenoid valve, servo pinch valve, etc. By selectively opening and closing these valves 640a, b, the device 100 and system are thus be able to direct the pumps 630 effects to individual additive cartridges 110a, b as desired. By pumping air into an additive cartridge 110, the pump 630 can force the syrup out of the cartridge, through the output tubing 650a, b, and into the beverage mixture. Meanwhile, by reverse pumping air back out of the additive cartridge 110a, b, syrup can be drawn back into the cartridge from the output tubing 650a, b.

Further, while output tubing 650 is shown, some embodiments do not incorporate output tubing and additive may be output directly from an output port of the cartridge. Such implementations are discussed at length below. The drawing of syrup, or any other additive, back into the cartridge 110, may thereby prevent unwanted dripping from the cartridge’s output port or output tubing 650.

As shown, the fluid delivery system has at least one pressurized conduit 600, shown as tubing connected to the additive cartridges 110a, b. Air pressure in the pressurized conduit 600 may then be applied to an inlet 610a, b of a corresponding additive cartridge 110a, b in order to force the contents of the corresponding additive cartridge out through an outlet 620a, b.

In some embodiments, the pressurized conduit 600 is maintained in a pressurized manner, and a controllable valve 640 is provided in association with the additive cartridge 110 in order to control whether the cartridge should be exposed to the pressure of the conduit 600. In other embodiments, the conduit 600 is pressurized by the pump 630 on demand in order to force contents out of the relevant additive cartridge 110.

In some embodiments, such as that shown in FIG. 6, multiple additive cartridges 110a, b are provided, each typically providing distinct additives. In such embodiments, the pressurized conduit 600 may be split into multiple conduits 600a, b, each corresponding to a single additive cartridge 110a, b. In such an embodiment, each additive cartridge 110a, b, may be provided with a corresponding controllable valve 640a, b, such that the valves can be used to determine which of the additive cartridges 110a, b are exposed to the pressure in the corresponding conduit 600a, b. In some alternative embodiments, instead of a single pump pressurizing all cartridges 110a, b by way of the valves 640a, b as shown, a single pump could be paired with each cartridge.

The additive cartridges 110a, b, may contain minerals, flavoring, or coloring for beverages, among other potential additives, typically in some concentrate form, such as a syrup. Typically, when multiple cartridges 110a, b are provided, the valves 640a, b may be opened either simultaneously or consecutively in order to add precise amounts of the additives from each cartridge in order to create a custom drink. In such a manner, the device 100 can incorporate, for example, flavoring from one cartridge 110a and minerals from a second cartridge 110b. Further, the valves 640a, b may be calibrated to allow for the precise application of additives to drinks by, for example, partially open or open for a precise amount of time. In some embodiments, multiple identical additives cartridges 110 may be incorporated so as to increase the speed of the depositing of additives into a beverage.

While the precise amount of syrup dispensed may be tracked by determining how much fluid is pumped into a cartridge 110, the amount of syrup dispensed may also be tracked by determining how much syrup, or how many drops of syrup, have been dispensed from the cartridge. This is discussed in more detail below with respect to FIG. 52A-49.

In some embodiments, the additive cartridges 110a, b, may be available in a wide variety of user selectable options, such as different drink flavors, colors, or other additives. The additive cartridges 110a, b may then be encoded with recipes, instructions, or general information, readable by the device 100, that account for an amount of syrup required for a particular drink, viscosity of the syrup contained, and/or other details specific to the contents of the cartridge.

As shown in FIG. 6, the outlet 620 of each additive cartridge may be connected to output tubing 650a, b. In this manner, the output tubing 650a, b may transport the additive to an additive output for the device 100, such as a glass or bottle filling location or a fluid mixing location.

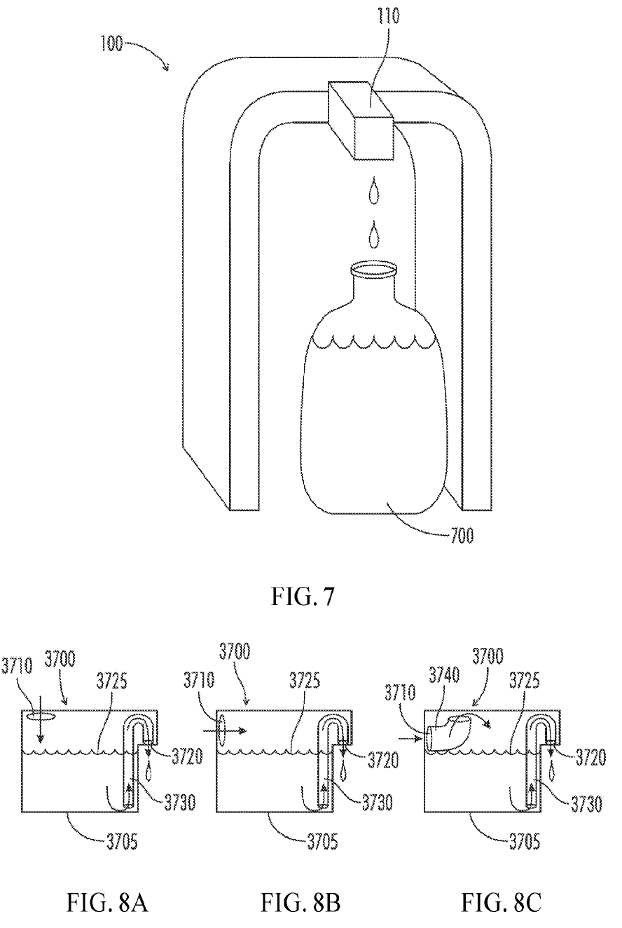

FIG. 7 shows a perspective view of the additive cartridges 110 dispensing additives in the context of the device of FIG. 1. As shown, the additive cartridges 110 may be mounted directly above an additive output location for the device 100 such that the additive is output directly into a drinking vessel, such as a bottle 700 for a beverage.

Accordingly, to prevent any need to clean the ‘output tubing’ 650, it is also possible to eliminate the output tubing entirely. If the additive cartridge 110 is docked onto the machine in a position such that the cartridge’s outlet 620 is directly above the user’s drinking vessel 700, the syrup could be output from the cartridge 110 directly into the drinking vessel, without the need to horizontally transport the syrup via tubing. In this way, when the additive cartridge 110 is removed from the machine, there are no remaining components on the machine that have come into physical contact with the syrup in any form. This is advantageous, as the cartridge 110 can typically be cleaned more easily than the rest of the machine by, for example, placing it in a dishwasher. Additional features easing the cleaning of the cartridge 110 are discussed in more detail below.

FIGS. 8A-C show additive cartridges 3700 for use with the device 100 of FIG. 1. As discussed above, with respect to FIG. 7, such cartridges 3700 may be designed to drip syrup directly into a user’s beverage or beverage vessel. As shown, the cartridge 3700 generally contains a syrup reservoir 3705 and has an air input hole 3710 which could, for example, interface with the air tubing 600a, b of FIG. 6, to connect the air input hole to the pumps discussed above. The cartridge 3700 further comprises a syrup output hole 3720, and a tube 3730 for transporting syrup from a syrup reservoir 3705 to the syrup output hole 3720.

As shown in FIG. 8A, the air input hole 3710 may be on a top surface of the cartridge 3700. Alternatively, as shown in FIGS. 8B and C, the air input hole 3710 may be on a side surface. If the air input hole 3710 is on a side surface, the syrup reservoir 3705 could have a fluid fill level 3725 below the location on the side surface at which the air input hole is provided, as in FIG. 8B. Alternatively, an anti-syphon tube 3740 may be provided in association with the air input hole 3710, such that the fill level 3725 of the syrup reservoir 3705 can be higher than the air input tube, as shown in FIG. 8C. Accordingly, even where the air input hole 3710 is below the fluid fill level 3725, the anti-syphon tube 3740 directs pressure from the fluid inlet above the fluid fill level. While the air input hole 3710 is shown in FIGS. 8B and C as opposite the syrup output hole, it will be understood that in some embodiments, the air input hole may be located on the same side of the cartridge 3700 as the syrup output, depending on aesthetics and mechanical configurations of the device 100. Further, because the syrup output hole 3720 may be downward facing and the air input hole 3710 may be horizontal, the two openings may be on adjacent surfaces, rather than on the same surface of the cartridge 3700.

As shown, the cartridge 3700 may therefore comprise a cartridge housing, shown as reservoir 3705, for retaining fluid up to the fluid fill level 3725, a fluid inlet 3710, typically for receiving air, for pressurizing the cartridge 110, and a fluid outlet 3720 above the fluid fill level 3725. The cartridge may further comprise a syphon, such as an output tube 3730, for transporting fluid from below the fluid fill level 3725 inside the cartridge reservoir 3705 to the fluid outlet 3720. Accordingly, when pressure is applied at the fluid inlet 3710, it causes fluid from the cartridge 3700 to dispense at the fluid outlet.

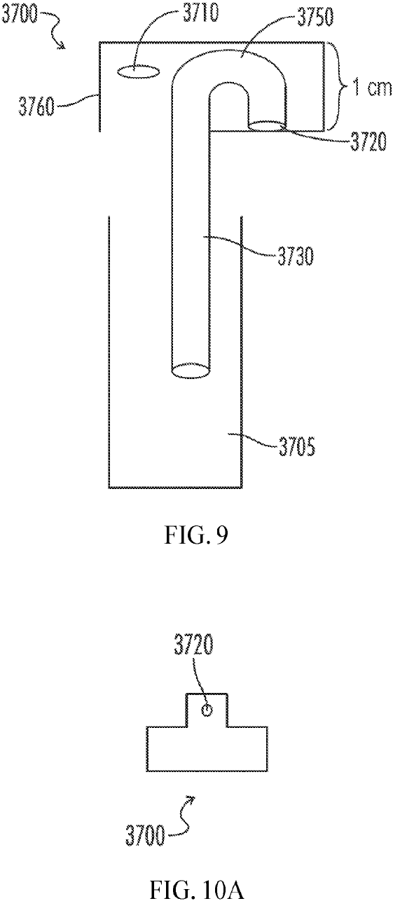

FIG. 9 shows an output tube 3730, also referred to as a syphon, for use in the context of the additive cartridges 3700 shown in FIGS. 8A-C. Note that sample dimensions are shown, but the tube may have a wide variety of dimensions. As shown, the output tube 3730 extends up from the syrup reservoir 3705, forms an upside down U 3750, and connects to a downward facing syrup output hole 3720. In such an embodiment, a main body, which may be the syrup reservoir 3705, may be detachable from a cap 3760, as shown. The syrup output tube 3730 may then be integrated into or connected to the cap 3760. When assembled, the bottom of the tube 3730 extending into the syrup reservoir 3705 may extend to the bottom of the reservoir so that it can receive all syrup within the cartridge 3700, and the syrup output hole 3720 faces downward, and is typically placed above a user’s beverage vessel or beverage. In this way, syrup drips directly into the bottle and does not require additional tubing for transport.

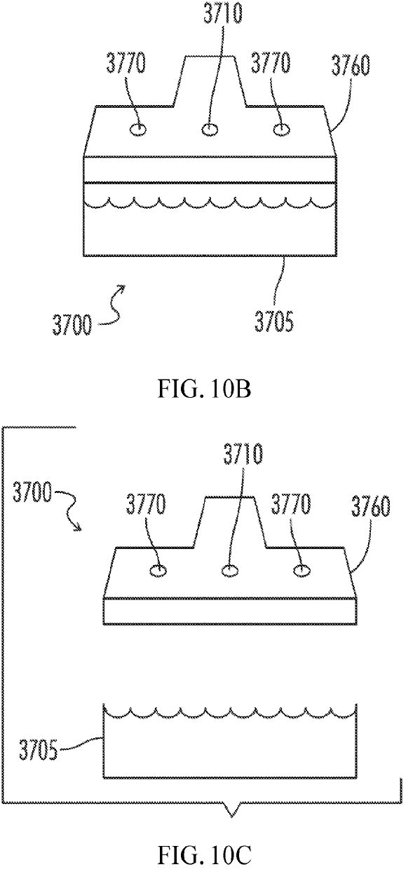

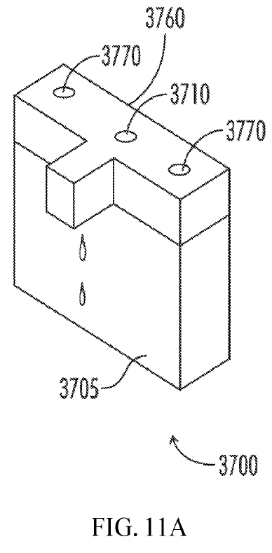

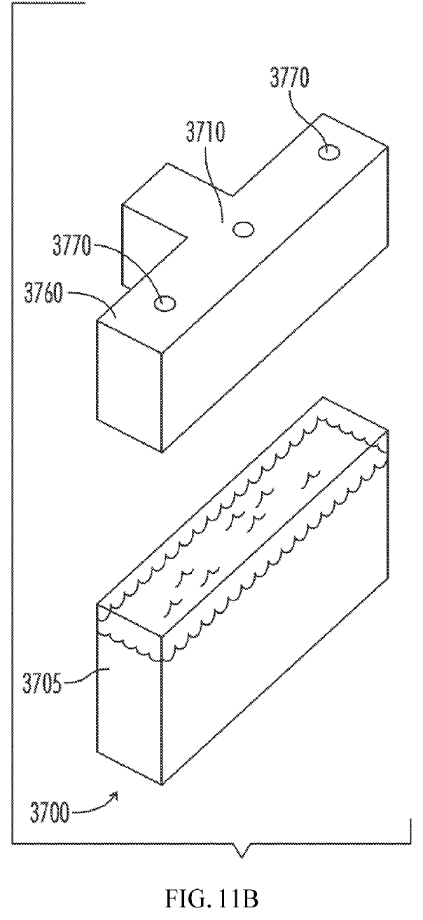

FIGS. 10A, B, and C show views of an additive cartridge 3700 according to this disclosure. FIGS. 11A and B show views of an embodiment of an additive cartridge 3700 according to this disclosure. FIG. 10A shows a bottom view of a cartridge 3700 as described, showing the syrup output hole 3720 on a downward facing surface on the cartridge. FIG. 10B shows a front view of the cartridge 3700 assembled, and shows the air input hole 3710 on a front surface. Further, as shown in FIGS. 11A and B, the air input hole 3710 may be on a top surface of the cartridge 3700, and it may be on a surface adjacent to the syrup output hole 3720. FIG. 10B further shows fixation elements 3770 for removably mating the cartridge 3700 with the device 100. In the embodiment shown, those fixation elements may take the form of magnets 3770, which may connect to corresponding magnets on the device 100. As shown in FIG. 10C, the cap 3760 of the cartridge 3700 may be removable from the syrup reservoir 3705.

In the embodiments shown, the cartridge 3700 has a removable cap. The removal of the cap 3760 allows the user to more easily clean and refill the cartridge 3700. Accordingly, the main body, comprising the syrup reservoir 3705 can be washed in a washing machine since it has a large opening for water to easily flow in. Further, the cap 3760 can be easily washed under a sink by positioning the syrup tubing under the water falling from the user’s faucet. While specific embodiments are described, it is contemplated that the cartridge 3700 may be further disassembled to further ease cleaning, or to render the entire assembly machine washable.

Cleaning tubes typically presents problems because tubes are long, small diameter channels which are difficult to clean using traditional cleaning mechanisms, such as high velocity water directed perpendicularly to the tubing wall or scrubbing. Users of a refillable cartridge 110, such as those described, are unlikely to have specialized cleaning skills or equipment. Accordingly, a new tube design is described and shown.

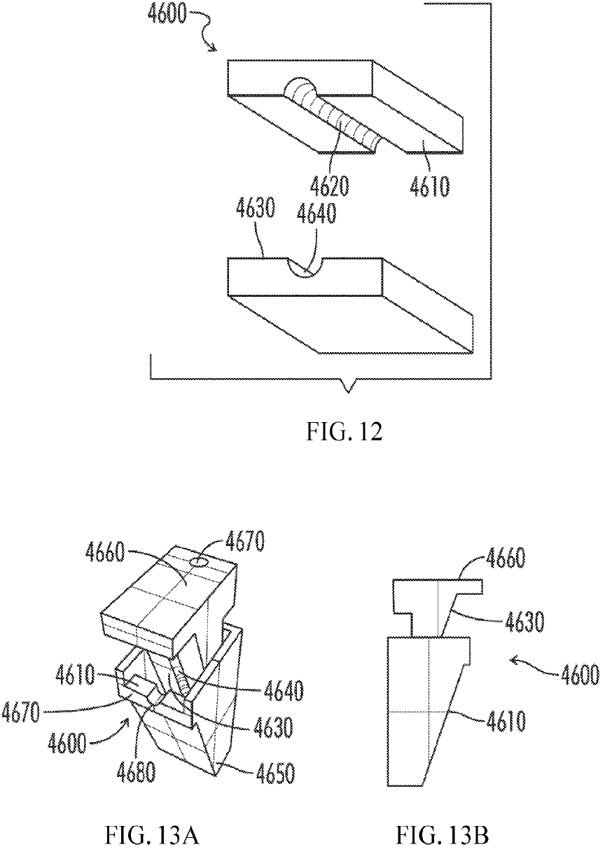

For example, one way in which the cleaning process can be eased is by replacing the syphon tube, or syrup output tubing 3730, with a deconstructed tube 4600, shown in FIG. 12-13B. As shown, the deconstructed tube 4600, or syphon, may comprise a first surface 4610 having a first surface groove 4620, and a second surface 4630 having a second surface groove 4640. In such an embodiment, both the first and second surface 4610, 4630 may be compressed against each other such that the first and second surface grooves 4620, 4640 combine to form the syphon tube 4600. While the embodiment shown provides two surfaces having grooves, it will be understood that grooves could be provided in only one of the two surfaces without compromising the integrity of the deconstructed tube 4600.

As shown, the first and second surfaces 4610, 4630 may be planar surfaces. Alternatively, the surfaces may be provided with some curvature to ease the incorporation of such surfaces into a cartridge 110.

In such an embodiment, the deconstructed tube 4600 may be opened along its length, such that the tubes inner walls can be easily exposed and washed either by hand or in a dishwasher.

FIGS. 13A-B show a perspective view and a side view of the deconstructed syphon tube 4600 incorporated into a cartridge 110. As shown, the cartridge may have a cartridge housing comprising a reservoir 4650 and a lid 4660. The first surface 4610 may then be an extension of the lid 4660 and the second surface 4630 may be an interior surface of the housing 4650.

In such a structure, the cartridge 110 acts as both a reservoir and a dispenser for syrup. In order to dispense additive syrup, an external pump applies pressure at an inlet 4670, thereby pushing additive through the deconstructed syphon 4600 to an outlet spout 4680.

As shown, the first surface 4610 and the second surface 4630 may be angled relative to a closure direction of the cartridge 110. In order to facilitate a tight coupling between the surfaces 4610, 4630 that would allow for a fluid tight seal, the mating surfaces are angled such that when a user compresses the lid 4660 against the housing 4650, the surfaces are pushed against each other. This seal allows the substantially vertical transport of fluid by way of the surface grooves 4620, 4640, by applying pressure to the interior of the housing 4650 at the inlet 4670.

In this implementation, as well as all other implementations where the cartridge 110 has a removable cap or lid 4660, the ability to seal the cap to the housing 4650 is important. Such a seal may be enhanced by applying force magnetically. Accordingly, the lid 4660 may be compressed against the housing 4650 using a magnetic closure. Such compression may reinforce the integrity of the deconstructed syphon tube 4600.

Forming good pneumatic seals is more difficult than forming good hydraulic seals, since gasses can more easily traverse through smaller seal imperfections (e.g. a gap or crack in the seal) than fluids can. Typical pneumatic seal solutions involve the use of O-rings or adhesives or fillers such as threadlock glue, silicone sealant, or Teflon tape, which may minimize gaps through which gases can flow. Such solutions may not work sufficiently for the cartridges 110 shown and described herein, since in many cases, the cartridge 110 must have a cap 4800 that can pneumatically seal to a dock 4810 for pumping air into the cartridge and the cap must further pneumatically seal with the base of the cartridge 4820. Further, in some embodiments, such as that shown in FIGS. 12A-13B, the deconstructed syphon must comprise a pneumatic seal as well, such that air cannot leak into the tube, as well as a hydraulic seal such that syrup cannot escape the grooves 4620, 4640.

These unique requirements stem from the fact that the cartridge 110 must be easily removable from the cartridge dock by an untrained user, the cartridge 110 cap and base must be easily washable in a dishwasher or by hand, and untrained users must be able to easily and repeatedly disconnect and reconnect the AP cap from the AP base. Accordingly, seals must have minimal crevices in which cartridge contents can accumulate, while also being non-permanent and easily coupled and decoupled with minimal skill.

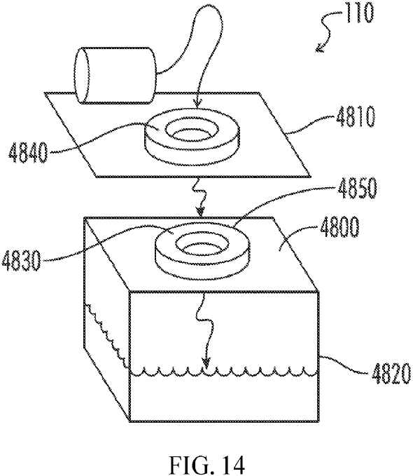

Accordingly, as shown in FIG. 14, seals may be provided as magnetic couplings. In such an embodiment, a magnet 4830 would be located on either the cartridge dock 4810 or on the cartridge itself 110, and the other of the two would have either another magnet or a ferromagnetic material 4840 for bonding to the magnet. To facilitate a good pneumatic seal, the magnet may fully encircle the pneumatic port, in this case the inlet 4850 through which air is pumped from the dock 4810 into the cartridge 110. The magnet 4830 and/or the ferromagnetic material 4840 may therefore be provided in a donut shape, which completely encircles the port.

By sandwiching a rubber-like material in the middle, a strong seal can be made. Because the seal is magnetic, no male/female or convexity/concavity matings are necessary for the coupling, and the coupling can be applied and decoupled by unskilled users.

In some embodiments, in order to further facilitate correct orientation of the cartridge 110 when docked with the dock 4810, either an additional magnet could be used, or a non-round shape could be used for the magnets, thereby biasing the couplings orientation to a desired orientation.

As discussed above, flavor and usage of additives from the cartridges 110 can be tracked by monitoring air pumped in to the cartridges. The additives may take the form of flavoring syrups, pH adjusting concentrates, or other fluids, and is usually monitored by controlling and monitoring actuators which control the dispensation of the additives from the cartridge 110 through a tube to a mixing or drinking vessel, such as a user’s glass. For instance, in using a stepper motor pump, a device 100 can ensure that the pump moves “100 steps” worth of an additive out of the additive reservoir and into the mixing vessel.

However, in many embodiments, such as where syrups or other additives may have different viscosities, usage may be tracked more precisely and accurately by monitoring the output of the cartridge 110. This may be, for example, by monitoring the weight of the vessel that the additive is being added to, by monitoring the passage of additives through an output tube using a flow sensor, such as a paddle wheel based sensor. However, such implementations require output tubing or otherwise require sophisticated scales or sensors.

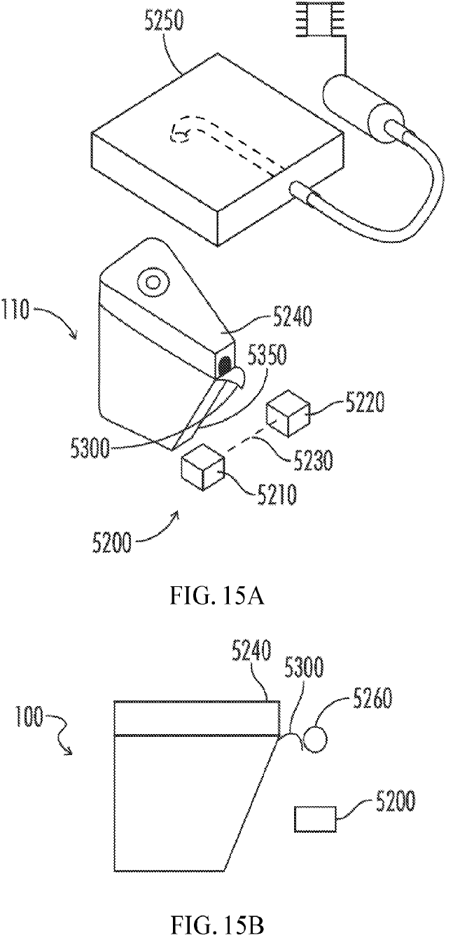

Alternatively, the tracking may be by use of a drop sensor 5200, as shown in the system of FIGS. 15A-B, in order to count drops output from the cartridges. A proposed setup for a drop counter assembly is shown in FIG. 15A as a partially exploded assembly. Such a setup is shown assembled in a side view in FIG. 15B. As shown, the monitoring may be by counting drops using, for example, an IR emitter 5210 paired with a sensor 5220 positioned on either side of a vertical passage through which additive drops fall. Accordingly, the IR beam’s default state is to shine across the passage from the IR emitter 5210 into the IR sensor 5220, and a drop of additive falling through the passage interrupts the beam 5230, allowing for detection.

By counting the number of droplets falling from an additive cartridge 110 into a mixing vessel, the device 100 can quantify the dispensation of additives in a way that is uniquely advantageous to a device utilizing a cartridge that is user-openable and can be refillable by the user with a wide array of additives that have varying viscosities.

Because user’s can both 1) remove and replace the cartridge 110 cap 5240, and 2) pour into the cartridge 110 syrups of varying viscosities, there can be variation in both 1) how airtight the AP’s cap-body seal is, and 2) how easy it is to push the additive out of the pod, respectively. Because of these variabilities, a system which controls only input parameters (e.g. commanding a stepper motor pump to move a certain number of steps), would not be able to accurately dispense a consistent amount of syrup from such cartridges 110. Meanwhile, by counting the number of additive drops that have fallen from the cartridge, the pump can operate as long as needed for the desired number of drops to be dispensed.

To ensure that syrup is dispensed from the cartridge 110 at a slow enough rate to create individual drops of additive, instead of a steady stream, two methods are disclosed. In a first method, if the machine knows the type of syrup inside a cartridge, then it will also know the viscosity of the syrup currently being dispensed, and it could select a pump power (e.g. via Pulse Width Modulation voltage control) appropriate for that viscosity. Alternatively, to ensure that additive is dispensed in individual droplets, the device 100 may gradually ramp up the supply voltage going to the air pump 120 (e.g. via Pulse Width Modulation), or repeatedly turn the pump on and off until the drop sensor detects that a drop has been dispensed. At this point the device 100 could maintain the voltage at the current level, or it could automatically increase the voltage slightly above the current level, to ensure a continuous and steady dispensation of drops.

Generally, when a fluid cartridge 110 is coupled to a docking location, the state of the cartridge is unknown (e.g. is the outlet orifice may be slightly clogged). Therefore, it would be useful for the docking location to be able to quickly ascertain the appropriate power level of the air pump 120 needed to dispense droplets from the cartridge 110 at any point in time. Such an auto-calibration could either occur whenever a cartridge 110 is newly inserted into the docking location, or it could occur at set time intervals (e.g. every 2 days).

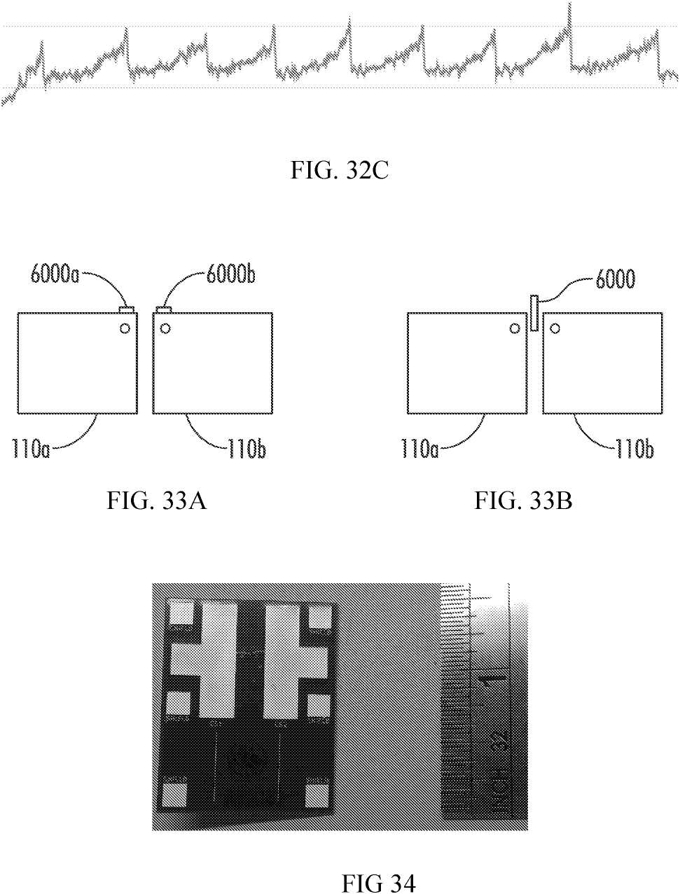

In order to perform this auto-calibration, the system 100 can make use of the upslope in signal detected by the capacitive drop sensing electrodes 6000, as shown in FIG. 32C and discussed below, when a droplet is forming in front of the electrode 6000. By gradually ramping up the air pump’s 120 power, the docking location could shut off the air pump immediately when the drop sensing electrode 6000 detects the start of an upslope in the sensed signal. In this way, the pump 120 would ramp up, a droplet would start forming at the outlet of the cartridge 110, and then the pump would turn off before the droplet has detached from the cartridge. The droplet would then be sucked back into the cartridge due to the bleeding off of headspace pressure due to a bleed valve, for example, as discussed below in reference to FIG. 15C. By saving the air pump PWM at which this droplet formed, the docking location can utilize this PWM whenever droplets are next requested from the machine.

Where the device 100 is provided with data relating to the liquid level in the pod, which may be determined by tracking syrup output from the pod or by detecting an amount of fluid remaining, the device can predict a good PWM level at which to start the PWM ramp, since the level required to dispense a drop depends on the current liquid level in the pod. In so doing, the machine can minimize the time needed to dispense the first drop from the pod.

The closed loop system described may keep track of the volume of liquid being dispensed from the cartridges 110 by sensing and counting the number of liquid droplets being dispensed from the cartridge. Therefore, in order to maintain a closed loop system, the liquid dispensation must always be in the form of droplets, the volume of which is well defined (-0.05 ml, for example), and not in the form of a stream of liquid which is more difficult to quantify with sensors.

The formation of droplets requires the flow rate of the liquid being dispensed to remain within a narrow band which allows drops to form at the desired frequency. Too low of a flow rate causes droplets to form too slowly, causing unacceptably long wait times for a user of the machine. Too high of a flow rate causes the liquid to be dispensed from the cartridge 110 as a stream, instead of as discrete droplets.

As previously discussed, preferred embodiments of this system 100 involve the use of air pumps 120 to pressurize the cartridges 110, thereby pushing liquid out of the cartridge’s outlet orifice. Smaller air pumps are often less reliable than larger air pumps, making it preferable to use larger air pumps if possible. The pumping speed of larger air pumps can be down-regulated by utilizing pulse width modulation (PWM) as their electrical control signal. Although PWM controlling the pumps can be dynamically modulated to maintain a specified flow rate, PWM can only decrease a pumps pumping speed by a certain amount before the pump refuses to even turn on when requested. To allow the use of larger air pumps without pumping air into the Pods at a rate that would cause a stream, instead of droplets, to be dispensed, mechanisms are described to slow the liquid dispensation rate.

As shown in FIG. 15C, one mechanism for decreasing the output of larger air pumps to an acceptably low, drop-forming range, is to incorporate a “bleed valve” within the air pathway from the air pump 120 to the docked fluid cartridge 110. This bleed valve is an orifice of known size (in some embodiments, 0.5 mm in diameter), which allows some of the air being pumped by the air pump to escape into the surrounding atmosphere, instead of over pressurizing the cartridge.

An additional benefit of the bleed valve is that it prevents hysteresis in the droplet dispensation, which would otherwise occur if the entire system 100 was fully air tight. Hysteresis is the continuation of dispensation even after the air pump 120 has been turned off. This occurs because the heightened air pressure in the headspace of the cartridge 110 which pushes out droplets continues to push droplets out of the cartridge until the cartridge’s headspace returns to atmospheric pressure. Without a bleed valve, the cartridge would return to atmospheric pressure by dispensing more droplets (which increases the headspace volume, thereby decreasing pressure). With the bleed valve, the excess pressure in the cartridge’s headspace is able to bleed retrograde back out the bleed valve after the pump 120 has been turned off.

The bleed valve can be incorporated in-line with the air tubing connecting the air pump 120 to the fluid cartridge 110, or can be incorporated into the cartridge itself.

The flow of dispensed liquid can also be slowed down at the cartridge’s outlet orifice. This can be achieved by either passive or active means. In the passive embodiment, an orifice of known size can be used (e.g. 0.5 mm diameter), with a pre- and post- orifice “tunnel” of wider diameter than the orifice to mechanically facilitate droplet formation. This may take the form of a flow control orifice, for example. In the active embodiment, a dynamic valve can be placed at the Pod’s outlet orifice, which restricts the flow of liquid dispensation.

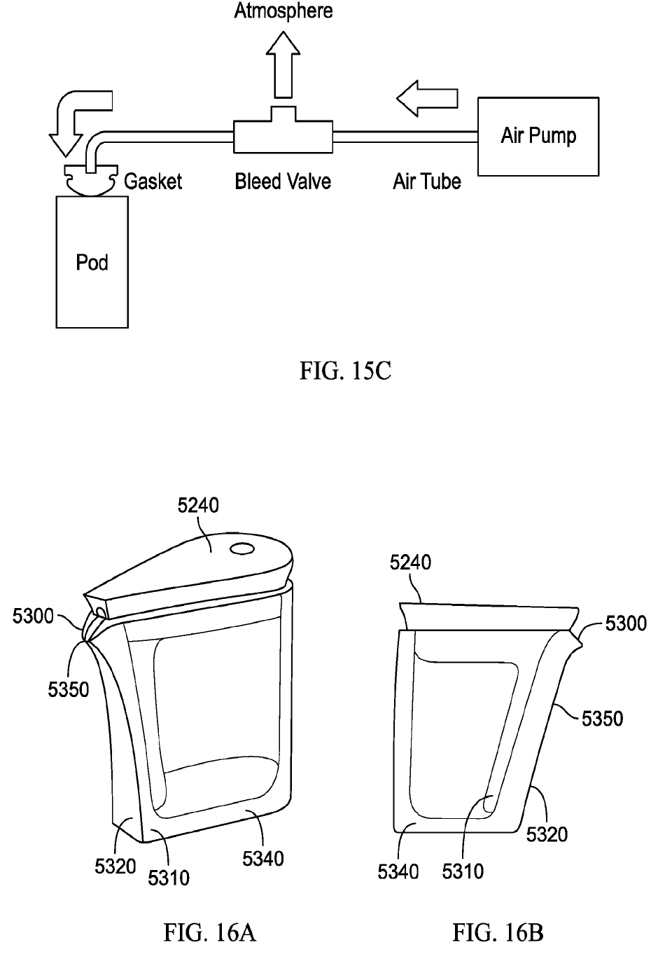

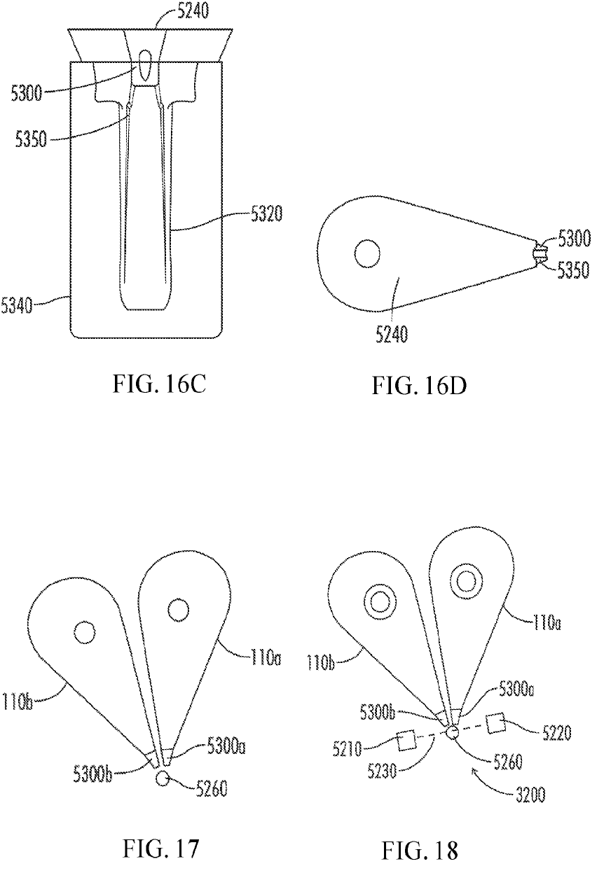

In order for a drop sensor to accurately evaluate a number of drops, it is useful for drops to fall consistently in a known location. FIGS. 16A-D show a perspective view, as well as a side, front, and top view respectively, of a cartridge 110 provided with a spout 5300 designed for precisely locating the drop as it is dispensed from the cartridge. Such a cartridge 110 is shown schematically in FIGS. 15A-B and may incorporate several features discussed in this specification.

Accordingly, the cartridge 110 may be provided with a deconstructed syphon, such as that shown above in FIG. 12-13B comprising a first surface 5310 having a first surface groove and a second surface 5320 having a second surface groove. The first surface may be an extension of the lid 5240 of the cartridge 110, while the second surface may be an inside surface of the housing 5340. While the grooves are not shown, the spout 5300 may be an extension of the second surface groove.

The spout 5300 is typically a downwardly curving channel, as shown, and is located at a corner 5350 of the cartridge 110. Accordingly, when the cartridge is docked in a pod dock 5250 and is placed in a known orientation, the drop location of droplets 5260 rolling off the spout 5300 will be precisely known.

In addition to knowing the precise location at which a drop will fall, a drip detection system will work best if all drops fall in substantially the same location. Where multiple cartridges 110a, b are used, a single drop sensor will work most effectively if the multiple cartridges dispense drops at the same, or in substantially the same location. Accordingly,

Accordingly, the cartridge 110 structure shown in FIGS. 15A-B and 16A-D is wedge shaped, with the wedge tapering substantially to the corner 5350 containing the spout 5300, so as to allow the positioning of multiple such cartridges adjacent each other in a dock, and such that the cartridges dispense drops at substantially the same location. Two such cartridges 110 adjacent each other are shown in FIG. 17. As shown in FIG. 18, this arrangement allows the drop sensor 5200 to detect a droplet 5260 from either cartridge 110.

Accordingly, as shown, an implementation of the device 100 may comprise a first fluid cartridge 110a comprising a first spout 5300a at a fluid outlet for dispensing a fluid, such as syrup, a second fluid cartridge 110b comprising a second spout 5300b at a similar fluid outlet, and a docking location for docking both cartridges 110a, b. When docked, the first spout 5300a is positioned adjacent the second spout 5300b such that droplets fall in the same place, which functions as a drop detection location. Because the cartridges 110a, b taper to their respective spouts 5300a, b, additional cartridges may be provided as well such that the cartridges form segments of a circle.

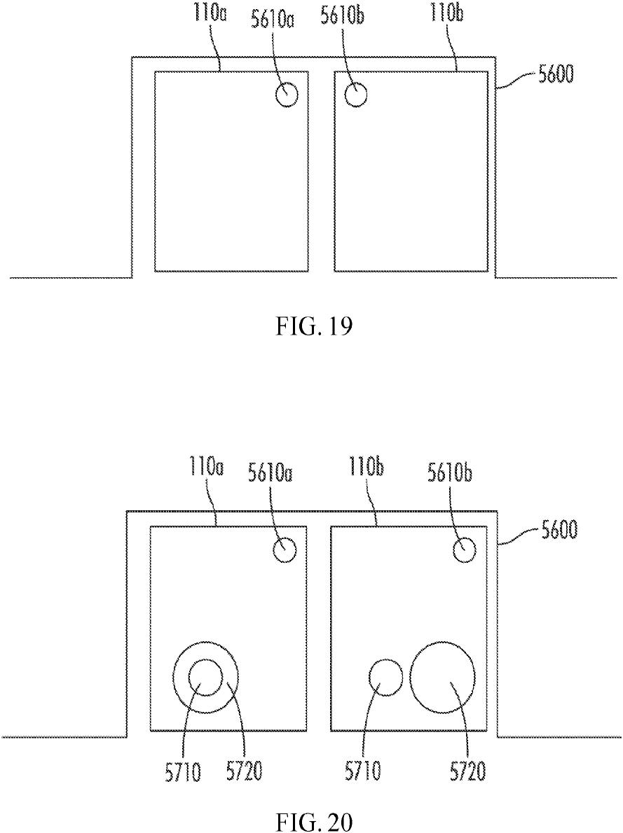

Alternatively, the outputs from a plurality of cartridges 110a, b may be located with spouts 5610a, b adjacent each other in other ways. As shown in FIG. 19, multiple square, or rectangular, cartridges 110a, b may be retained at a docking location 5600 of the device such that their respective spouts 5610a, b are rotated towards each other. Accordingly, each cartridge 110a, b has a square cap which allows the pod to be placed on either the left side or right side of the docking location 5600 by rotating the cartridge such that the spouts 5610a, b are oriented towards the center of the pod dock.

In order to ensure that the spouts 5610 are located at the specified location required, the docking location may incorporate detection mechanisms such that it can be confirmed that the cartridges are properly oriented. As shown in FIG. 20, this may include magnets in the cap 5710 and the dock 5720 respectively that must be properly aligned in order for the cartridges to mate with the dock. If such magnets are not aligned, the docking location 5600 may reject the cartridges 110a, b, or may not properly function.

The magnets 5710, 5720 may also serve to secure the air inlet port, and may be offset from the center of the corresponding cartridge cap 5730, such that an incorrect orientation will not allow coupling of the cartridge cap 5730 to the docking location 5600. Another option is for there to be more magnets oriented at the corners of the pod cap in north/south orientations that prevent incorrect user orientation of the pod while docking it to the pod dock.

In some embodiments, magnetic couplings are provided, as shown, for example, in FIG. 20, in which various Pod Dock magnet orientations are provided for coupling to equivalent magnet orientations in the fluid cartridges 110a, b. In some embodiments, magnets are placed in both the Pod Dock and the fluid cartridges 110a, b in order to provide sufficient attraction to form an air-tight seal between the components in order to allow for the necessary pressurization of the pods, thereby allowing for consistent liquid dispensation.

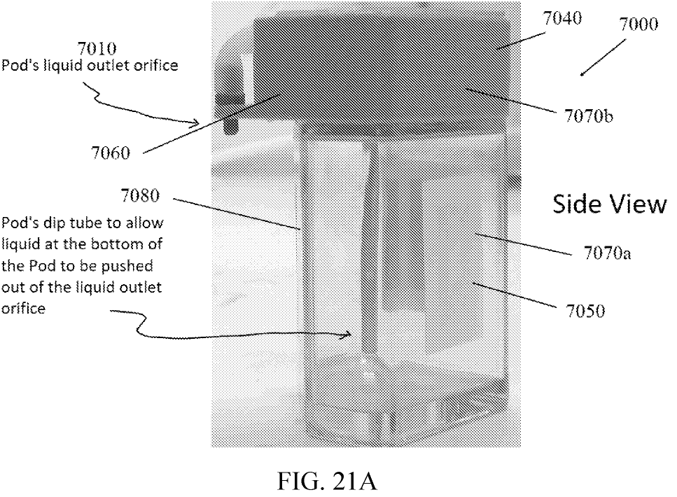

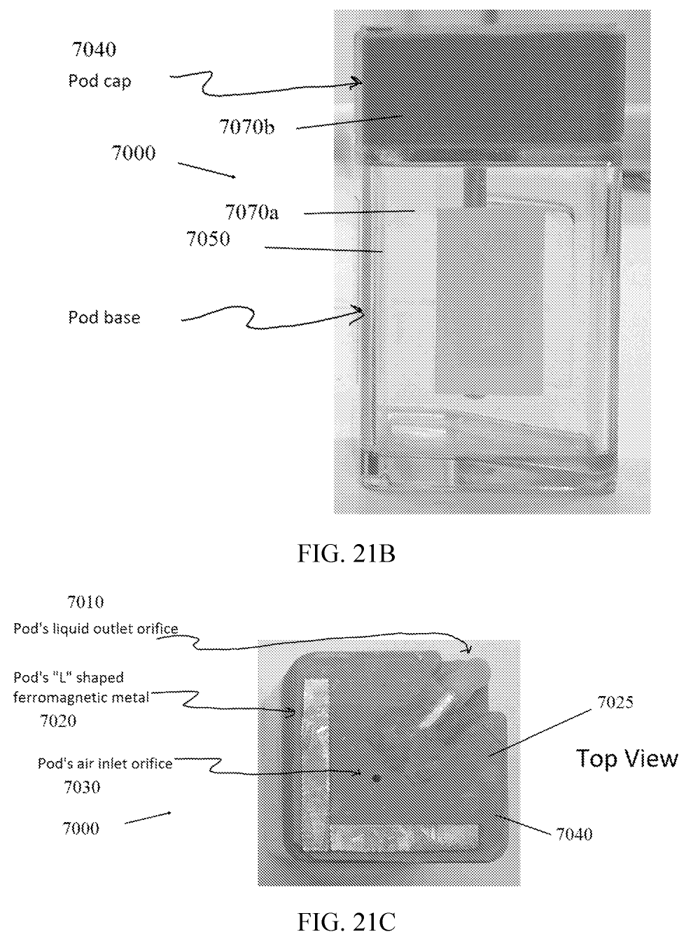

The embodiment shown in FIG. 21A-29 provides a design for forming a consistent air-tight or fluid-tight seal between docking locations 7110a, b and corresponding fluid cartridges 7000.

FIGS. 21A-C show a fluid cartridge 7000 for locating at a docking location in a device 100 in accordance with this disclosure. As shown, the fluid cartridge 7000 has a fluid outlet 7010 for dispensing fluid contained within the cartridge. The cartridge further has a ferromagnetic material 7020 at or adjacent a top face 7025 for mating with a magnetic fixation location of a corresponding docking location.

It is noted that the ferromagnetic material 7020 need not be a permanent magnet in the embodiment shown, thereby eliminating the need for a magnet to be embedded in the fluid cartridge 7000 and reducing the cost of materials. However, it will be understood that a magnet may be provided as the ferromagnetic material 7020.

The fluid cartridge 7000 has an inlet orifice 7030, and when pressure is applied to the fluid cartridge at the inlet orifice, fluid from the fluid cartridge is dispensed from the fluid outlet.

As shown, the fluid cartridge 7000 has an upper segment 7040, which may be a cap for the fluid cartridge, and a lower segment 7050 when vertically oriented. The lower segment 7050 may be a fluid reservoir for the cartridge. The upper segment 7040 is substantially rectangular when viewed from above, and is square in the embodiment shown, while the lower segment 7050 is not rectangular when viewed from below. As such, there is a portion 7060 of the rectangular upper segment 7040 that is not above the lower segment 7050 when the fluid cartridge 7000 is vertically oriented. As shown, the fluid outlet 7010 is located at the portion 7060 of the rectangular upper segment 7040 not above the lower segment 7050, such that when fluid is dispensed from the fluid outlet, it drops based the lower segment.

The upper segment 7040 is mated to the lower segment 7050 such that at least two sidewalls 7070a of the lower segment are coextensive with corresponding sidewalls 7070b of the upper segment, while at least one wall 7080 of the lower segment does not have a corresponding wall of the upper segment.

Accordingly, instead of using the donut shaped magnets discussed above with respect to FIGS. 14 and 20, the coupling of FIG. 21A-29 utilizes an “L” shaped magnet at each docking location 7110a, b and provides an “L” shaped ferromagnetic element 7020, such as a metal piece, on each fluid cartridge 7000 to couple the components.

It will be understood that while the ferromagnetic element 7020 is shown and described as disposed on a top face 7025 of the upper segment 7040 of the cartridge 7000, it may be embedded in the cartridge such that it is not visible. Further, the upper segment 7040 of the cartridge 7000 may be provided with a housing which would at least partially enclose the ferromagnetic element 7020.

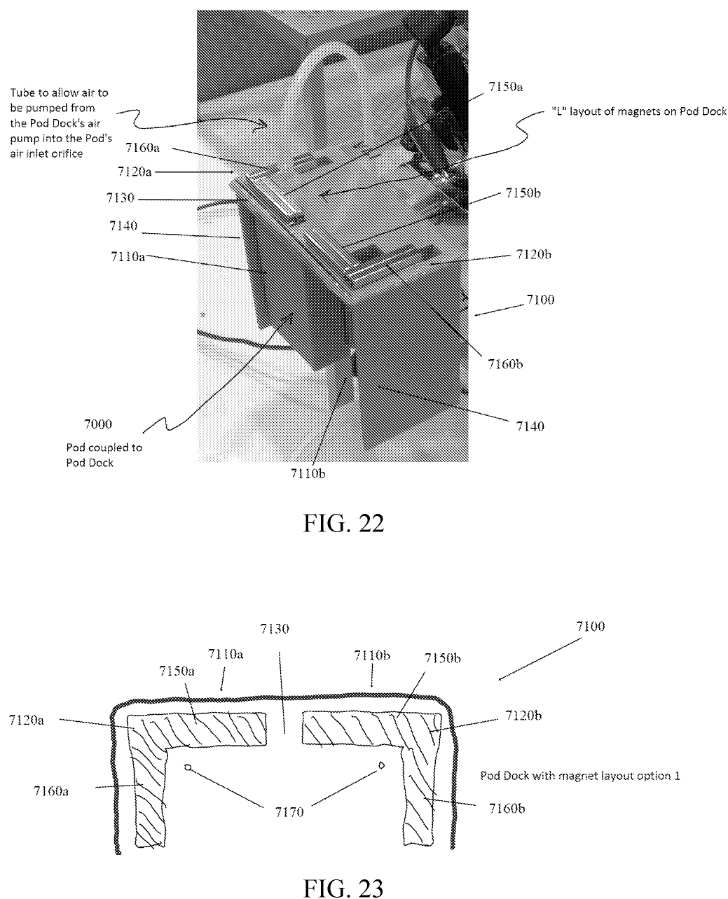

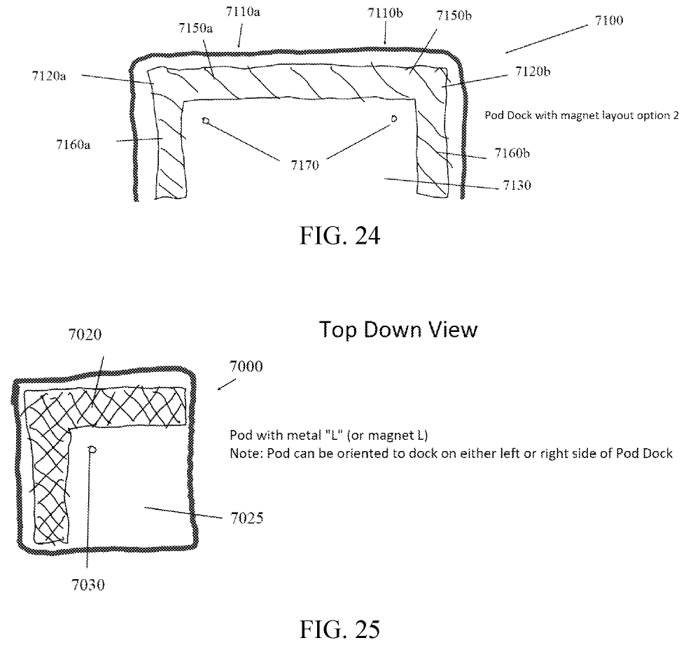

FIG. 22 shows a docking housing 7100 for housing docking locations 7110a, b for mating with iterations of the fluid cartridge 7000 of FIGS. 21A-C. FIG. 23 shows a schematic diagram of an embodiment of docking locations 7110a, b in the docking housing 7100 of FIG. 22. FIG. 24 shows a schematic diagram of a second embodiment of docking locations 7110a, b in the docking housing 7100 of FIG. 22. FIG. 25 shows a schematic diagram of a top face 7025 of the fluid cartridge 7000 of FIGS. 21A-C.

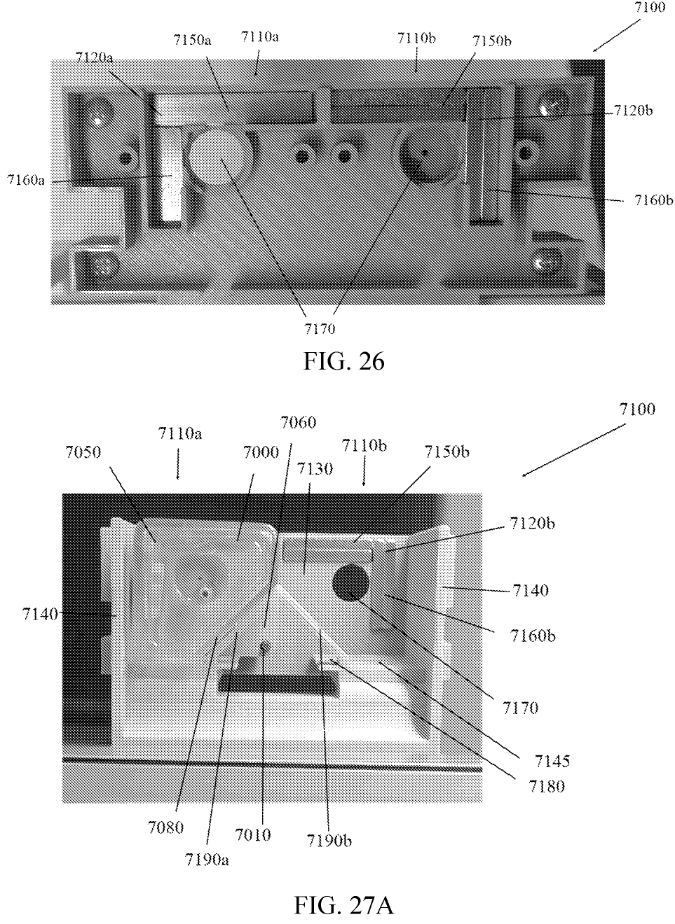

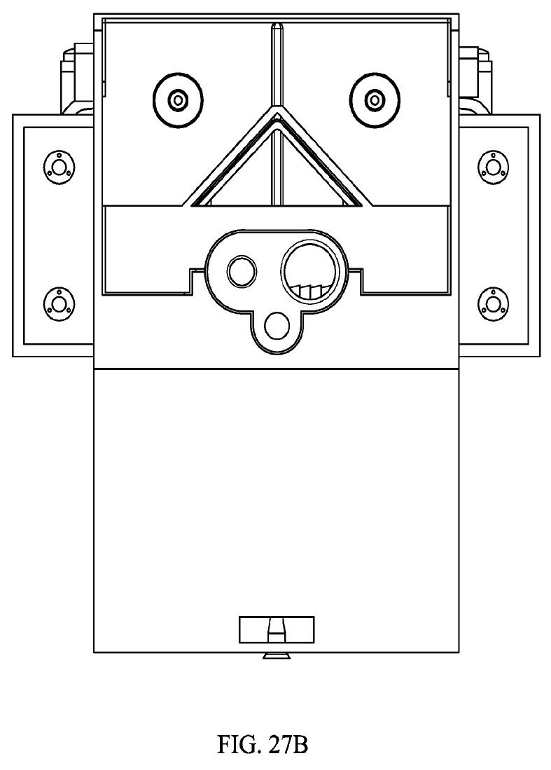

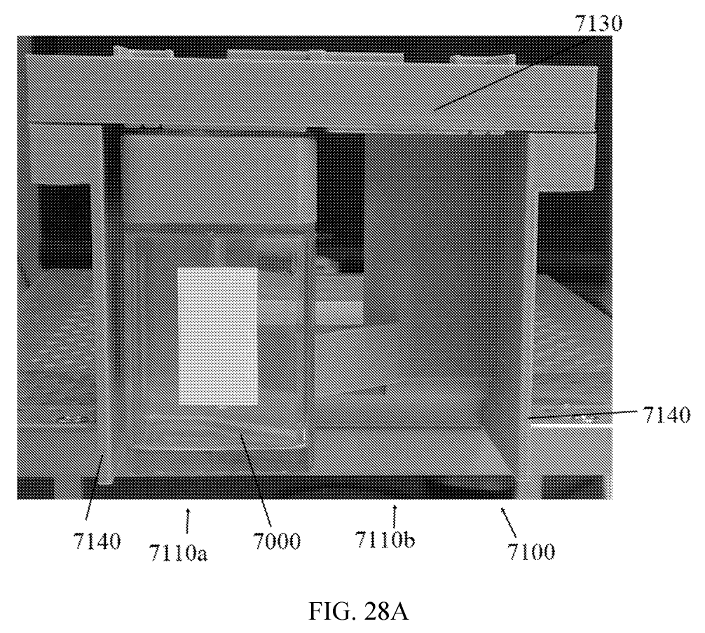

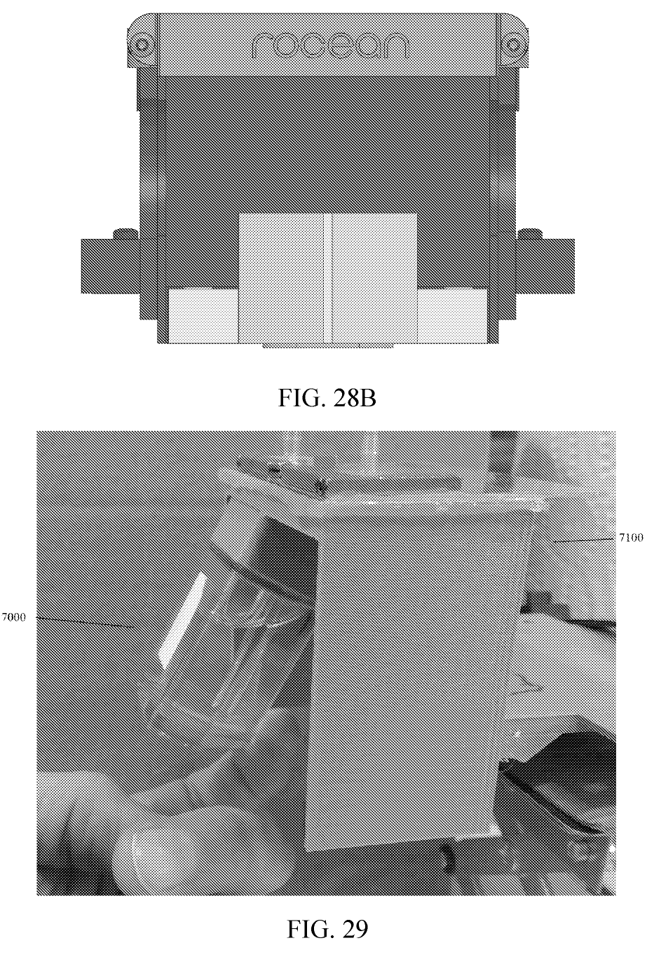

FIG. 26 shows a top view of the docking housing 7100 of FIG. 22. FIGS. 27A-B show a bottom view of the docking housing 7100 of FIG. 22. FIGS. 28A-B show a front view of the docking housing 7100 of FIG. 22.

In combination with the cartridges 7000, the device 100 forms a system for dispensing fluid having a first fluid cartridge 7000 and a second fluid cartridge (not shown), with each fluid cartridge generally taking the form discussed above with respect to FIGS. 21A-C. The system further has a first docking location 7110a and a second docking location 7110b for docking the first and second fluid cartridges 7000 respectively. Each docking location 7110a, b has a magnetic fixation location 7120a, b for mating with the ferromagnetic material 7020 at the top face 7025 of the cartridge 7000.

As discussed above with respect to the embodiments shown in FIG. 20, the magnetic fixation location 7120a, b may be arranged such that the corresponding fluid cartridge 7000 can only be applied in a specific orientation. For example, as shown, the first docking location 71110a and the second docking location 7110b are both located within a docking housing 7100, and the docking housing has a top surface 7130, a plurality of side surfaces 7140, and at least one back surface 7145. The front of the docking housing 7100 is open, as is the bottom.

In such an embodiment, the magnetic fixation location 7120a, b for each docking location 7110a, b is at least partially located at the top surface 7130 adjacent the open front of the docking housing 7100.

Further, in the embodiment shown, each docking location 7110a, b is adjacent a side surface 7140 of the docking housing 7100, and the magnetic fixation location 7120a, b for each docking location has a first magnetic element 7150a, b at the top surface 7130 adjacent the front of the docking housing 7100 and a second magnetic element 7160a, b adjacent the side surface 7140 adjacent the corresponding docking location 7110a, b.

As shown in FIG. 22, in some embodiments, the magnetic fixation location 7120a, b may comprise several magnets making up the first and second magnetic elements 7150a, b, 7160a, b. As shown in FIG. 23, a single L shaped magnet may be provided, where one leg of the L functions as the first magnetic element 7150a, b, and a second leg of the L functions as the second magnetic element 7160a, b.

Further, as shown in FIG. 24, in some embodiments, the first magnetic element 7150a of the first docking location 7110a and the first magnetic element 7150b of the second docking element 7110b may be segments of the same magnetic element. In some such embodiments, both magnetic fixation locations 7120a, b may be combined in a single C shaped magnet crossing both sides of the docking housing. This approach can simplify and reduce the cost of manufacturing by minimizing the number of magnetic components that must be incorporated.

Accordingly, the magnetic fixation location 7120a, b of each of the docking locations 7110a, b forms an L shaped segment at a top surface 7130 of a docking housing 7100. The ferromagnetic material 7020 of the fluid cartridge 7000 then forms a similar L shaped segment at or near a top face 7025 of the cartridge adjacent two side surfaces of the corresponding fluid cartridge.

As discussed above, two sidewalls 7070a of the lower segment 7050 are coextensive with two sidewalls 7070b of the upper segment 7040 of the cartridge. In the embodiment shown, the two legs of the L shaped ferromagnetic material 7020 are adj acent the two coextensive sidewalls 7070b of the upper segment 7040.

In contrast, the fluid outlet 7010 is at the portion 7060 of the upper segment 7040 not having a lower segment below it. This portion 7060 of the upper segment 7040 is typically at a corner opposite the coextensive sidewalls 7070b of the upper segment 7040, and therefore opposite the upper face 7025 from the ferromagnetic material 7020.

The docking locations 7110a, b further comprise a pump outlet 7170 for applying a pumping force to the inlet orifice 7030 of the cartridge 7000. As shown, the pump outlet 7170 may be in the top surface 7130 in the docking housing 7100, and may be located adjacent a corner of the magnetic fixation location 7120a, b where the first magnetic element 7150a, b and the second magnetic element 7160a, b meet for each docking location 7110a, b.

Similarly, the inlet orifice 7030 of the fluid cartridge 7000 is located adjacent the corner of the L shaped segment of ferromagnetic material 7020 of the fluid cartridge. Accordingly, when a fluid cartridge 7000 is located at the first docking location 7110a and the magnetic fixation location 7120a is fixed to the ferromagnetic material 7020, the pump outlet 7170 is coupled to the inlet orifice 7030, and when pressure is applied to the first fluid cartridge 7000 at the inlet orifice 7030, fluid from the cartridge is dispensed from the fluid outlet 7010.

Accordingly, when the fluid cartridge 7000 is installed at the first docking location 7110a, fluid can be dispensed from the fluid outlet 7010 by applying force at the pump outlet 7170 by way of a pump, so long as the cartridge 7000 is properly oriented in a specific orientation. While the fluid cartridge 7000 is shown in the first docking location 7110a, it is understood that the cartridge 7000 could also be located at the second docking location 7110b. Similarly, multiple cartridges 7000 could be provided, with one applied at the first docking location 71 10a and a second applied at the second docking location 7110b.

Accordingly, the L shaped magnet layout concentrates pulling force on the fluid cartridge 7000 at the location of the inlet orifice 7030. In some embodiments, a compressible interface is provided at the inlet orifice 7030 on the fluid cartridge 7000 and/or at the pump outlet 7170 of the docking housing 7100. The compressible interface may be, for example, a gasket, a grommet, or an O-ring at that location, such that an airtight seal can be maintained between the inlet orifice 7030 of the fluid cartridge 7000 and the pump outlet 7170 of the docking housing 7100. Other known air-tight interfaces may be provided as well, including interfaces made from incompressible materials. In some embodiments, the compressible interface is a gasket which is friction-fit into the air tubing of the pump outlet 7170 of the docking housing 7100.

The configuration of the magnetic fixation location 7120a, b and the location of the ferromagnetic material 7020 results in a single correct orientation where both legs of the L forming the magnetic fixation location 7120a, b are applied to both legs of the corresponding ferromagnetic material.

Such a configuration results in the portion 7060 of the upper segment 7040 not located above the lower segment 7050 of the fluid cartridge 7000 being positioned adjacent the back surface 7145 of the docking location housing 7100.

Because the magnet of the magnetic fixation locations 7120a, b strongly attract the ferromagnetic material 7020 on the fluid cartridge 7000, it would be possible for users unfamiliar with the system to improperly orient the fluid cartridges when attempting to dock them in the docking locations 7110a, b causing the cartridges to be coupled to the docking housing 7100 in a non-functional way (i.e., with the cartridge’s inlet orifice 7030 not lined up with the pump outlet 7170 of the docking location 7110a, b). To prevent this from occurring, orienting walls, such as bracing elements 7180, can be designed into the back surface 7145 of the docking housing 7100. One example of a traingular-shaped orienting wall is shown in FIGS. 27A-28B. The triangular shape of this wall prevents cartridges 7000 from being inserted in anything but the correct orientation, as can be seen in FIG. 27.

As shown, the back surface 7145 of the docking housing 7000 may be provided with a bracing element 7180. When the cartridge 7000 is installed, the bracing element 7180 contacts the sidewall 7080 of the lower segment 7150 of the cartridge that is not coextensive with a corresponding sidewall of the upper segment 7140. The bracing element 7180 takes the form of vertical walls 7190a, b, each extending at an angle relative to the back surface 7145 of the docking housing 7100. The vertical walls 7190a, b therefore form a triangle with the back surface 7130 at a center of the back surface, such that one vertical wall 7190a forms a partial boundary of the first docking location 7110a and the second vertical wall 7190b forms a partial boundary of the second docking location 7110b.

As shown, when the fluid cartridge 7000 is located at the first docking location 7110a, and when the docking housing 7100 is viewed from below, the lower segment 7050 of the fluid cartridge 7000 is located on a first side of the corresponding vertical wall 7190a and the portion 7060 of the upper segment 7040 not over the lower segment is located on a second side of the vertical wall 7190a opposite the first side. As such, any fluid dispensed from the fluid outlet 7010 of the fluid cartridge 7000 falls within the triangle formed by the bracing element 7180.

Further, because the bracing element braces against the specified wall 7080 of the lower segment 7050 of the cartridge 7000, the cartridge can only be placed in the docking location the specific orientation discussed above in which the magnetic fixation location 7120a, b mates with the ferromagnetic material 7020 of the fluid cartridge 7000.

The two vertical walls 7190a, b forming the bracing element 7180 each applies this affect to their corresponding docking locations 7110a, b, such that cartridges 7000 can only be applied to either docking location in the correct orientation.

In addition to seal-forming functionality, the L shaped magnet fixation locations 7120a, b provide an enhanced user experience, due to a “magnetic hinge” effect. When looking at the docking housing 7100 from the front, as shown in FIGS. 28A-B, the first magnetic element 7150a, b which runs left-to-right adjacent the front of the docking housing is exerting high amounts of attractive force on the front-most edge of the fluid cartridge 7000. Because of this, when the user pulls on the bottom of the fluid cartridge 7000 to remove it from the first docking location 7110a, the front-most edge of the fluid cartridge 7000 remains connected to the docking location, creating an elegant hinging motion during the fluid cartridge’s undocking, which 1) requires minimal user force to support the weight of the fluid cartridge 7000 until the cartridge is fully disconnected from the docking location 7110a, and 2) allows the fluid cartridge 7000 to automatically swing back into a docked position if the user lets go of the cartridge during the removal process in “mid-hinge.” FIG. 29 illustrates this magnetic hinge effect.

FIG. 29 shows a user removing a fluid cartridge of FIGS. 21A-C from the docking housing 7100 of FIG. 22. As shown, the first magnetic element 7150a forms a magnetic hinge with the ferromagnetic material 7020 of the cartridge 7000, such that when a lower end of the first fluid cartridge 7000 is pulled away from the back surface 7130 of the docking housing 7100, the first fluid cartridge rotates about the first magnetic element.

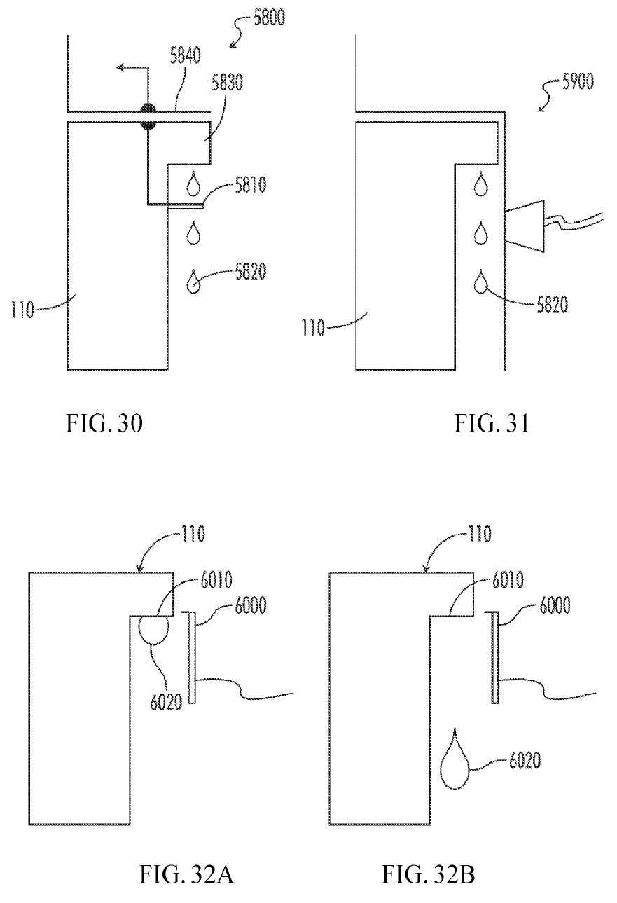

The drop sensor is shown in FIGS. 15A-B as a beam 5230 between two units, typically a laser emitter 5610 and a detection unit 5620. Alternatively, the drop sensor 5200 may be a capacitive sensor 5800, as shown in FIG. 30, or a reflective object sensor 5900, as shown in FIG. 31.

The capacitive sensor 5800, may comprise a single conductive element 5810 (e.g. a single wire, straight or looped) that is positioned to be in the path of falling drops 5820 being dispensed from the pod 110. This type of sensor requires either contact, or close proximity to a conductive substance (e.g. a falling droplet) in order to trigger detection. Before drops 5820 are dispensed, a baseline reading is taken from the sensor 5800. Subsequently, to detect drops 5820 as they fall, a microcontroller simply evaluates the sensor’s 5800 readings for a change in capacitance that is representative of a drop 5820 passing or contacting the sensor wire. Because the capacitive sensor could be as simple and cheap as a single conductive wire, it can be mounted to the cartridge itself 110, and connected to the machine’s circuitry via a conductor-to-conductor connection between the cartridge cap 5830 and the cartridge dock 5840.

This capacitive sensor 5800 could also serve a dual purpose by allowing the device 100 to detect when a pod has been mounted to the cartridge dock 5840. Because the circuitry to process capacitive sensor data resides in the device 100, the capacitance measured by this circuitry changes when the cartridge 110 is mounted to the dock 5840. This is because, by mounting a cartridge 110 to the dock 5840, the capacitive sensing circuitry in the machine is coupled to the capacitive sensing wire 5810 on the cartridge 110, effectively “elongating” the circuitries sensing wire to extend down onto the cartridge. Because of this large change in the sensed capacitance that occurs when a pod is docked to the machine, this large change in capacitance can be assumed to be due to the mounting of a cartridge 110 to the cartridge dock 5840 if 1) it occurs at a time when drops are not being actively dispensed by the device 100, and 2) the change is within the range expected to occur when a cartridge 110 is mounted to the dock 5840.

In case the capacitive sensing wire 5810 does come into contact with the falling droplets 5820, the capacitive sensing wire can be easily cleaned by removing the cartridge 110 from the dock 5840, and placing it into a dishwasher, or washing by hand. Alternatively, a UV LED in the device 100 can be positioned such that it shines on the capacitive sensing wire 5810, thereby continuously ensuring maximum sanitization.

Another type of sensor that can detect drops is a reflective object sensor 5900, which makes use of the fact that water is IR reflective. Such a reflective object sensor comprises an IR emitter and an IR detector oriented such that they are angled towards each other in a way so that if a reflective object is placed at a certain distance in front of them, it allows reflection of the emitter IR beam back into the detector. This sensor 5900 would be mounted within the device 100, and would not make contact with the drops 5820.

FIGS. 32A-B show an implementation of a capacitive sensor for use in the device 100 with the cartridge 110. FIG. 32C shows a signal extracted from the capacitive sensor during use. As shown, instead of a sensing wire 5810 incorporated into the cartridge 110, a capacitive sensor 6000 is located adjacent a dispensing location 6010 of the cartridge 110. As shown, as a fluid droplet 6020 forms at the dispensing location 6010, the capacitance in the sensor 6000 increases from a baseline. This can be seen in the signal shown in FIG. 32C.

When the droplet 6020 falls away from the dispensing location 6010, as shown in FIG. 32B, the droplet falls out of a detection range of the electrode of the sensor 6000. This is represented as a sudden dropoff visible in FIG. 32C returning the signal to its baseline. Accordingly, each spike in FIG. 32C represents a droplet 6020 building within the detection zone and then falling away from the dispensing location 6010.

FIG. 33A shows a first implementation of a capacitive sensor 6000 for use with multiple cartridges 110a, b. As shown, separate capacitive sensors 6000a, b may be provided for use with each cartridge. In this way, a device 100 may be provided with docking location for several cartridges, and each cartridge may be provided with an independent sensor. FIG. 33B shows an alternative in which a single capacitive sensor 6000 is provided for use with multiple cartridges 110a, b by placing such a sensor between the cartridges being monitored.

To use a non-contact capacitive electrode 6000 for detecting droplets 6020 as they are dispensed from the cartridge 110, it helps to have the cartridge’s dispensing location 6010 positioned immediately above the top edge of the capacitive sensor 6000, such that as the droplet 6020 forms at the dispensing location 6010, before the droplet has detached from the pod, the capacitance sensed by the electrode increases, as shown in FIG. 32C. Then, once the droplet 6020 reaches a large enough size such that gravity detaches the droplet from the cartridge 110, the droplet quickly falls out of the capacitive sensor’s 6000 range, thereby causing it to detect a very sudden drop in capacitance. This sudden drop can be used to indicate that a droplet 6020 has just been dispensed into the user’s vessel.

Such a capacitive electrode can also be used to detect when the user has attached or detached a CO2 tank from the device 100, since CO2 tanks are made of metal. Accordingly, when connecting the tank, the tank could contact a capacitive electrode, thereby changing the capacitance sensed by the electrodce. This could be achieved in a non-contact way, since the large amount of metal involved would cause a significant change in the capacitance detected by a nearby capacitive electrode.

In consulting available literature on capacitive electrode design, both from scientific journals, and from manufacturers of capacitive sensor integrated circuits (ICs), various electrode designs were found and tested, but all were found to be inappropriate for our needs due to unacceptably low signal to noise ratios when attempting to measure droplets being dispensed ~3mm away from the capacitive sensing electrode.

While capacitive sensors have been used in the past as a non-contact way of determining liquid levels within vessels, the detection of falling droplets using such sensors is uncommon.

A preferred embodiment, shown schematically in FIGS. 32A-B, involves the fluid cartridge’s 110 outlet orifice 6010 being positioned so that it is horizontally aligned with the top edge of the capacitive sensing electrode 6000, and is ~3 mm away from the electrode. Such a configuration causes a forming droplet 6020 to induce a gradual ramping up of the signal detected by the electrode 6000, followed by an extremely rapid drop in the detected signal when the droplet finally detaches from the fluid cartridge’s 110 outlet orifice 6010 and falls past and away from the electrode 6000 due to gravity.

FIG. 34 shows electrodes for use in the capacitive drop sensor of FIGS. 32A-B and 33A. The design shown provides a T shaped electrode 6000 and is located adjacent the dropping location. As shown in FIG. 33A, two electrodes 6000a, b are provided,w ith one adjacent the drop location for each of two cartridges 110a, b. The electrode shown can detect droplets dispensed at > 3 Hz. In a comparison between square, “L”, and “T” electrode designs, the “T” electrode performed the most consistently.

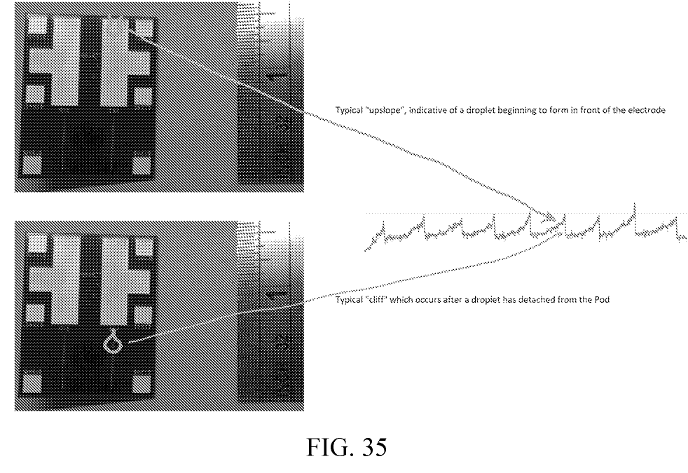

FIG. 35 shows the electrodes of FIG. 34 in use and compares them to the data of FIG. 32C. As shown, when a droplet forms adjacent the upper edge of the electrode 6000, the signal shows a gradual upslope. When the droplet finally detaches, the signal shows an immediate drop-off.

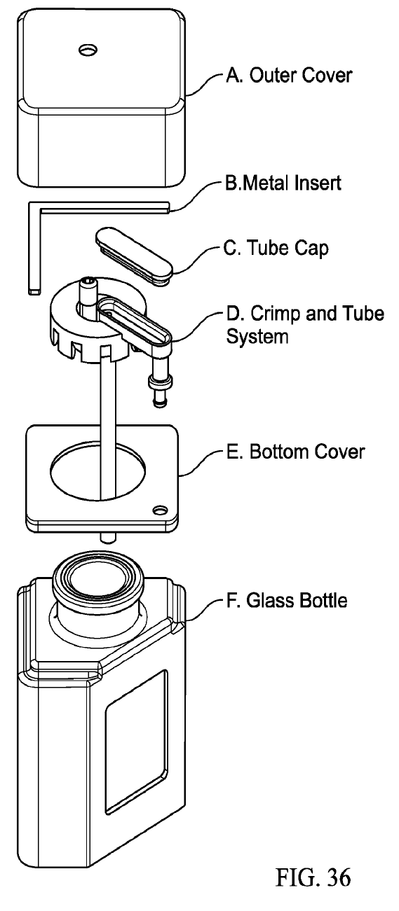

FIG. 36 shows a fluid cartridge assembly, including a crimp and tube system, for use in the device of FIG. 1.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A system for dispensing fluid comprising:
a first fluid cartridge comprising a first fluid outlet for dispensing fluid;
a second fluid cartridge comprising a second fluid outlet for dispensing fluid;
a first docking location for docking the first fluid cartridge; and
a second docking location for docking the second fluid cartridge;
wherein each docking location has a magnetic fixation location for mating with a ferromagnetic material on the corresponding fluid cartridge.

2. The system of claim 1, wherein the first and second docking locations require that the corresponding fluid cartridges be docked in a specific orientation.

3. The system of claim 2, wherein the first docking location and the second docking location are located within a docking housing, wherein the docking housing has a top surface, a plurality of side surfaces, and at least one back surface, and wherein a front of the docking housing is open, and wherein the magnetic fixation location for each docking location is at least partially located at the top surface adjacent the front of the docking housing.

4. The system of claim 3, wherein each docking location is adjacent a side surface of the docking housing, and wherein the magnetic fixation location for each docking location comprises a first magnetic element at the top surface adjacent the front of the docking housing and a second magnetic element adjacent the side surface adjacent the corresponding docking location.

5. The system of claim 4, wherein the first magnetic element of the magnetic fixation location for the first docking location and the first magnetic element of the magnetic fixation location for the second docking element are segments of the same magnetic element.

6. The system of claim 4, wherein the ferromagnetic material for each fluid cartridge comprises an L shaped segment at or near a top surface of the cartridge adjacent two side surfaces of the corresponding fluid cartridge.

7. The system of claim 6, wherein the first fluid outlet of the first fluid cartridge is adjacent a corner of the cartridge opposite the ferromagnetic material of the first fluid cartridge.

8. The system of claim 6, wherein the first fluid cartridge further comprises an inlet orifice for applying pressure to an interior of the first fluid cartridge, the inlet orifice being adjacent the corner of the L shaped segment of ferromagnetic material of the first fluid cartridge.

9. The system of claim 8, wherein the docking location further comprises a pump outlet located adjacent a corner of the magnetic fixation location where the first magnetic element and the second magnet element meet for each docking location, such that when the first fluid cartridge is located at the first docking location and the magnetic fixation location is fixed to the ferromagnetic material, the pump outlet is coupled to the inlet orifice of the first fluid cartridge, and wherein when pressure is applied to the first fluid cartridge at the inlet orifice, fluid from the cartridge is dispensed from the fluid outlet.

10. The system of claim 3, wherein the first fluid cartridge comprises a rectangular upper segment and a non-rectangular lower segment, such that at least a first portion of the upper segment is not above the lower segment when vertically oriented.

11. The system of claim 10, wherein the first fluid outlet is located at the first portion of the upper segment.

12. The system of claim 11, wherein the first fluid outlet is adjacent the at least one back surface when the first fluid cartridge is in the specific orientation.

13. The system of claim 12, wherein at least two sidewalls of the lower segment are coextensive with at least two sidewalls of the upper segment of the first fluid cartridge, and wherein the at least one back surface comprises a bracing element for contacting a sidewall of the lower segment that is not coextensive with a corresponding sidewall of the upper segment.

14. The system of claim 13, wherein the bracing element comprises a vertical wall angled relative to the at least one back surface of the docking location, and wherein the lower segment of the first fluid cartridge is opposite the bracing element from the first spout.

15. The system of claim 14, wherein the bracing element comprises two vertical walls forming a triangle with the at least one back surface at a center of the back surface, such that a first of the two vertical walls contacts the sidewall of the lower segment of the first fluid cartridge and wherein a second of the two vertical walls contacts an equivalent sidewall of the second fluid cartridge, thereby orienting both the first fluid cartridge and the second fluid cartridge in their respective specific orientations.

16. The system of claim 4, wherein the first magnetic element forms a magnetic hinge with the ferromagnetic material of the cartridge, such that when a lower end of the first fluid cartridge is pulled away from the at least one back surface of the docking housing, the first fluid cartridge rotates about the first magnetic element.

17. The system of claim 1, wherein the ferromagnetic material is metal.

18. The system of claim 1, wherein the ferromagnetic material is a magnet.
